(19) United States
(12) Patent Application Publication
(10) Pub. No.: US 2025/0126442 A1
(43) Pub. Date: Apr. 17, 2025

(54) METHOD AND APPARATUS FOR NTN STORE AND FORWARD PROCEDURE IN A WIRELESS COMMUNICATION SYSTEM

(71) Applicant: ASUS Technology Licensing Inc., Taipei City (TW)

(72) Inventor: Meng-Hui Ou, Taipei City (TW)

(21) Appl. No.: 18/913,644

(22) Filed: Oct. 11, 2024

Related U.S. Application Data
(60) Provisional application No. 63/544,064, filed on Oct. 13, 2023.

(51) Int. Cl. H04W 4/14; H04L 51/214

(52) U.S. Cl. CPC H04W 4/14; H04L 51/214

(57) ABSTRACT

Methods, systems, and apparatuses are provided for Non-Terrestrial Network (NTN) Store and Forward (S&F) procedures in a wireless communication system, with a method of a first network node comprising receiving a transmission from a User Equipment (UE), and determining to respond to the transmission to the UE based on a feeder link of the first network node being not available and a service associated with the transmission is a Short Message Service (SMS).

### CROSS-REFERENCE TO RELATED APPLICATIONS

The present application claims priority to and the benefit of U.S. Provisional Patent Application Ser. No. 63/544,064, filed Oct. 13, 2023, which is fully incorporated herein by reference.

### FIELD

This disclosure generally relates to wireless communication networks and, more particularly, to a method and apparatus for Non-Terrestrial Network (NTN) store and forward procedures in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for Non-Terrestrial Network (NTN) Store and Forward (S&F) procedures in a wireless communication system, wherein the procedures can be well handled in S&F mode.

In various embodiments, a method of a first network node comprises receiving a transmission from a User Equipment (UE), and determining to respond to the transmission to the UE based on a feeder link of the first network node being not available and a service associated with the transmission is a Short Message Service (SMS).

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIGS. 4.1-1: Non-terrestrial network typical scenario based on transparent payload, from 3GPP TR 38.821 V16.0.0.

FIG. 6 is a reproduction of FIGS. 4.1-2: Non-terrestrial network typical scenario based on regenerative payload, from 3GPP TR 38.821 V16.0.0.

FIG. 7 is a reproduction of FIG. 5.2.1-1: Regenerative satellite without ISL, gNB processed payload, from 3GPP TR 38.821 V16.0.0.

FIG. 8 is a reproduction of FIG. 5.2.1-2: Regenerative satellite with ISL, gNB processed payload, from 3GPP TR 38.821 V16.0.0.

FIG. 9 is a reproduction of FIG. 5.2.2-1: NG-RAN with a regenerative satellite based on gNB-DU, from 3GPP TR 38.821 V16.0.0.

FIG. 10 is a reproduction of FIG. A-1: Illustration of “normal/default operation” and “S&F operation” modes in a 5G system with satellite access, from 3GPP TR 22.865 V2.0.0.

FIG. 11 is a reproduction of FIG. 5.4.3-1: Animal tracking in the remote areas, from 3GPP TR 22.865 V2.0.0.

FIG. 12 is a reproduction of a potential call flow for intermittent feeder link figure, from 3GPP RWS-230178.

FIG. 13 is a reproduction of FIG. 4.2.3-1: Non-Roaming 5G System Architecture, from 3GPP TS 23.501 V18.1.0.

FIG. 14 is an example diagram illustrating an NTN network, in accordance with embodiments of the present invention.

FIG. 15 is an example diagram of UP data flow in S&F mode, in accordance with embodiments of the present invention.

FIG. 16 is an example diagram of a procedure in normal mode, in accordance with embodiments of the present invention.

FIG. 17 is an example diagram of failure of a procedure/transmission, in accordance with embodiments of the present invention.

FIG. 18 is an example diagram showing that a UE may (determine whether to) initiate a first procedure based on whether the UE is in S&F mode and/or whether the feeder link is available, in accordance with embodiments of the present invention.

FIG. 19 is an example diagram showing that a network node may receive a request of a first procedure from a UE, in accordance with embodiments of the present invention.

FIG. 20 is an example diagram showing that a network node may receive a request of a first procedure from a UE and may suspend the request if the network node is in S&F mode, in accordance with embodiments of the present invention.

FIG. 21 is an example diagram showing that a network node may receive a request of a first procedure from a UE and the network node (e.g., the satellite NW) may transmit (or resume, or forward, or relay) the request to the ground NW, in accordance with embodiments of the present invention.

FIG. 22 is an example diagram showing that a first network node (e.g., the satellite NW) may be provided with a configuration (or pre-configured) about a first procedure, e.g., by the second network node (e.g., the ground NW), in accordance with embodiments of the present invention.

FIG. 23 is an example diagram showing that a first network node may (determine whether to) respond to a transmission based on an operation mode (e.g., whether the first network node is in S&F mode), in accordance with embodiments of the present invention.

FIG. 24 is an example diagram showing that a first network node may (determine whether to) respond to a transmission based on an operation mode (e.g., whether the first network node is in normal mode), in accordance with embodiments of the present invention.

FIG. 25 is a flow diagram of a method of a UE comprising receiving an indication of operating in S&F mode, and determining whether to initiate a procedure based on whether the UE is operating in S&F mode, in accordance with embodiments of the present invention.

FIG. 26 is a flow diagram of a method of a first network node comprising transmitting an indication of operating in S&F mode, receiving a request of a procedure from a UE, and determining whether to reject the request based on whether the first network node is operating in S&F mode, in accordance with embodiments of the present invention.

FIG. 27 is a flow diagram of a method of a first network node comprising transmitting an indication of operating in S&F mode, receiving a request of a procedure from a UE, and determining whether to store the request based on whether the first network node is operating in S&F mode, in accordance with embodiments of the present invention.

FIG. 28 is a flow diagram of a method of a first network node comprising transmitting an indication of operating in S&F mode, receiving a request of a procedure from a UE, and determining whether to respond to the request based on whether the first network node is operating in S&F mode, in accordance with embodiments of the present invention.

FIG. 29 is a flow diagram of a method of a first network node comprising receiving a transmission from a UE, and determining to respond to the transmission to the UE based on a feeder link of the first network node being not available and a service associated with the transmission is an SMS, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TR 38.821 V16.0.0, “Solutions for NR to support non-terrestrial networks (NTN)”; [2] 3GPP TR 22.865 V2.0.0, “Study on satellite access Phase 3 (Release 19)”; [3] 3GPP TS 23.501 V18.1.0, “System architecture for the 5G system (5GS)”; and [4] 3GPP RWS-230178, “NR and IoT NTN”. The standards and documents listed above are hereby expressly and fully incorporated herein by reference in their entirety.

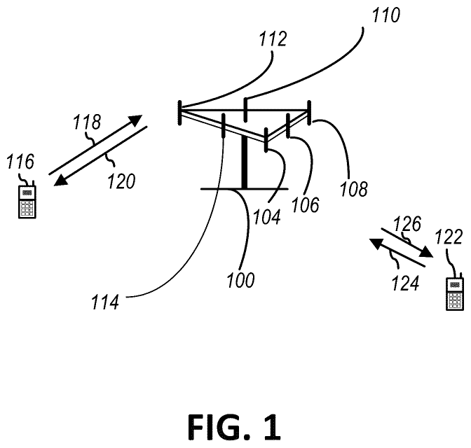

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

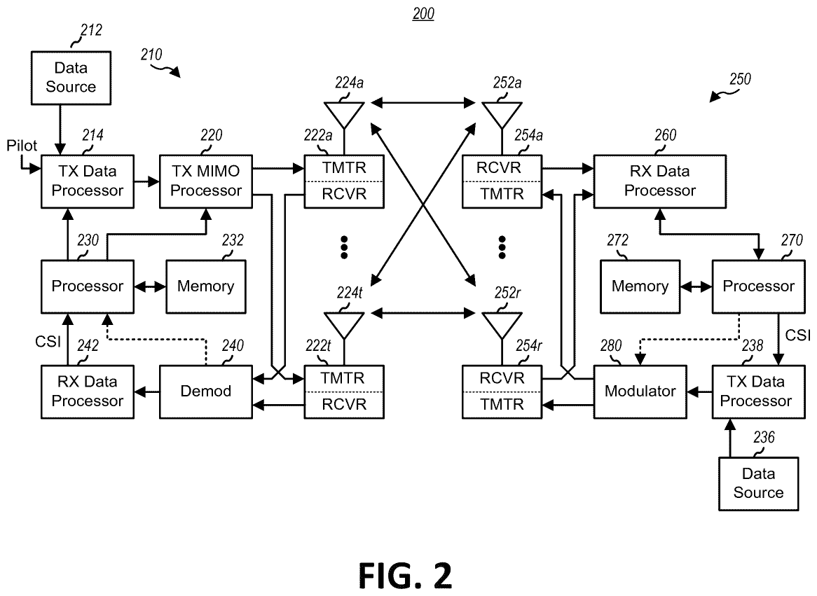

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from Nr antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

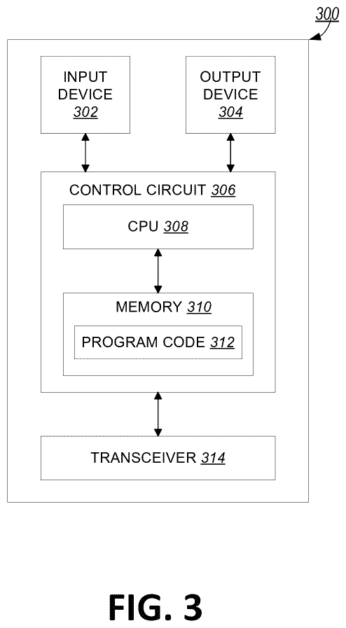

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

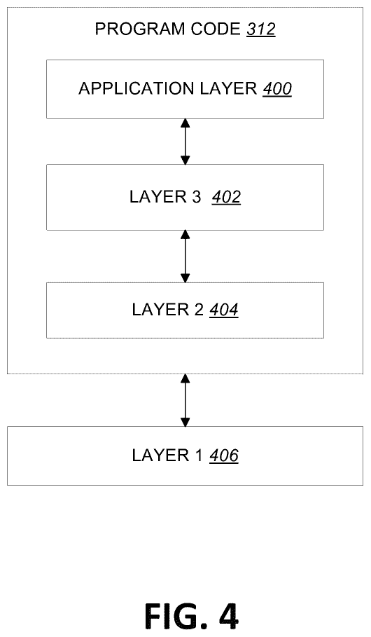

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 3GPP TR 38.821 ([1] 3GPP TR 38.821 V16.0.0), study on NR NTN (non-terrestrial networks) is introduced. NTN could be considered as networks, or segments of networks, using an airborne or space-borne vehicle to embark a transmission equipment relay node or base station. More descriptions are also specified in [1] 3GPP TR 38.821 V16.0.0:

### 4.1 Non-Terrestrial Networks Overview

A non-terrestrial network refers to a network, or segment of networks using RF resources on board a satellite (or UAS platform).

The typical scenario of a non-terrestrial network providing access to user equipment is depicted below:

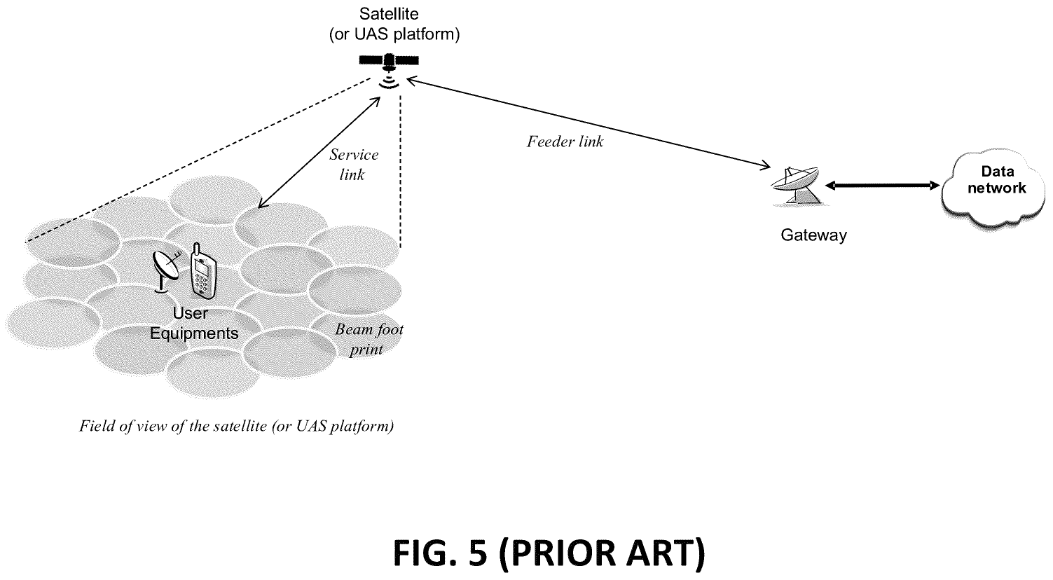

FIG. 5 is a reproduction of FIGS. 4.1-1: Non-terrestrial network typical scenario based on transparent payload, from 3GPP TR 38.821 V16.0.0.

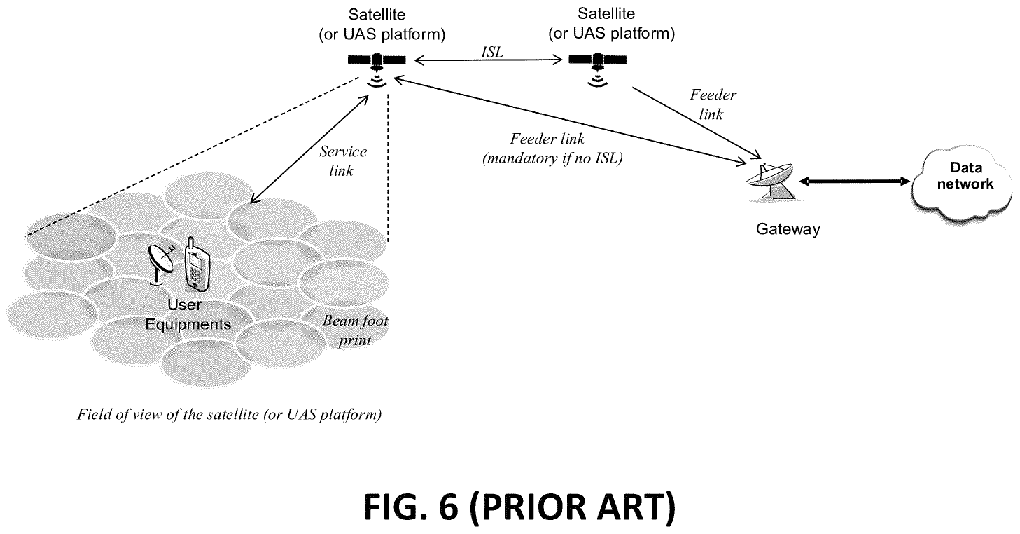

FIG. 6 is a reproduction of FIGS. 4.1-2: Non-terrestrial network typical scenario based on regenerative payload, from 3GPP TR 38.821 V16.0.0.

Non-Terrestrial Network typically features the following elements:
One or several sat-gateways that connect the Non-Terrestrial Network to a public data network
   a GEO satellite is fed by one or several sat-gateways which are deployed across the satellite targeted coverage (e.g. regional or even continental coverage). We assume that UE in a cell are served by only one sat-gateway
   A Non-GEO satellite served successively by one or several sat-gateways at a time. The system ensures service and feeder link continuity between the successive serving sat-gateways with sufficient time duration to proceed with mobility anchoring and hand-over
A Feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
   A transparent payload: Radio Frequency filtering, Frequency conversion and amplification. Hence, the waveform signal repeated by the payload is un-changed;
   A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment are served by the satellite (or UAS platform) within the targeted service area.

There may be different types of satellites (or UAS platforms) listed here under:

TABLE 4.1-1
Types of NTN platforms

| | | | | Typical beam | |
|---|---|---|---|---|---|
| Platforms | Altitude range | | Orbit | footprint size | |
| Low-Earth Orbit | 300-1500 | km | Circular around | 100-1000 | km |
| (LEO) satellite | | | the earth | | |
| Medium-Earth Orbit | 7000-25000 | km | | 100-1000 | km |
| (MEO) satellite | | | | | |
| Geostationary Earth | 35 786 | km | notional station | 200-3500 | km |
| Orbit (GEO) | | | keeping position | | |
| satellite | | | fixed in | | |
| UAS platform | 8-50 km (20 km | | terms of | 5-200 | km |
| (including HAPS) | for HAPS) | | elevation/ | | |
| | | | azimuth | | |
| | | | with respect | | |
| | | | to a given | | |
| | | | earth point | | |
| High Elliptical Orbit | 400-50000 | km | Elliptical around | 200-3500 | km |

| | |
|---|---|
| (HEO) satellite | the earth |

Typically
GEO satellite and UAS are used to provide continental, regional or local service.
a constellation of LEO and MEO is used to provide services in both Northern and Southern hemispheres. In some case, the constellation can even provide global coverage including polar regions. For the later, this requires appropriate orbit inclination, sufficient beams generated and inter-satellite links.

HEO satellite systems are not considered in this document.

### 5.2 Regenerative Satellite Based NG-RAN Architectures

### 5.2.1 gNB Processed Payload

### 5.2.1.1 Overview

The NG-RAN logical architecture as described in TS 38.401 is used as baseline for NTN scenarios.

The satellite payload implements regeneration of the signals received from Earth.
NR-Uu radio interface on the service link between the UE and the satellite.
Satellite Radio Interface (SRI) on the feeder link between the NTN gateway and the satellite.

SRI (Satellite Radio Interface) is a transport link between NTN GW and satellite.

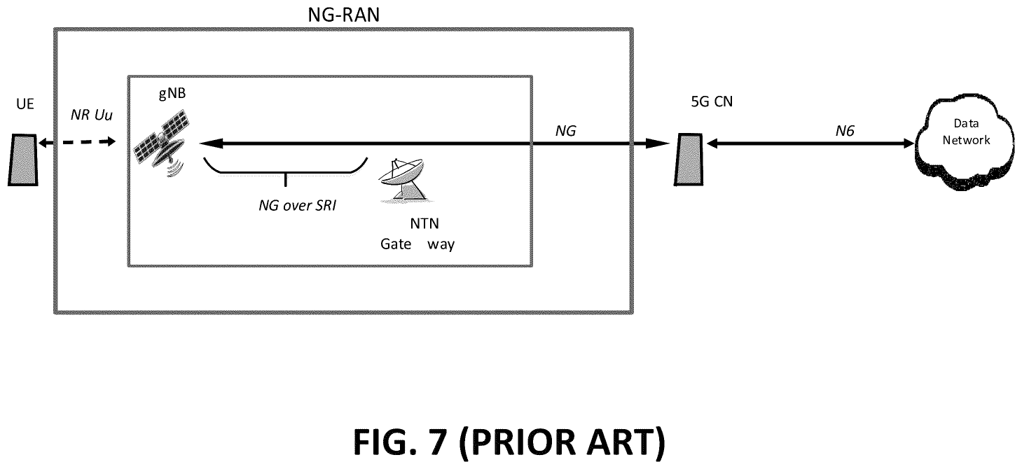

FIG. 7 is a reproduction of FIG. 5.2.1-1: Regenerative satellite without ISL, gNB processed payload, from 3GPP TR 38.821 V16.0.0.
NOTE: The satellite may embark additional traffic routing functions that are out of RAN scope.

The satellite payload also provides Inter-Satellite Links (ISL) between satellites

ISL (Inter-Satellite Links) is a transport link between satellites. ISL may be a radio interface or an optical interface that may be 3GPP or non 3GPP defined but this is out of the study item scope.

The NTN GW is a Transport Network Layer node, and supports all necessary transport protocols.

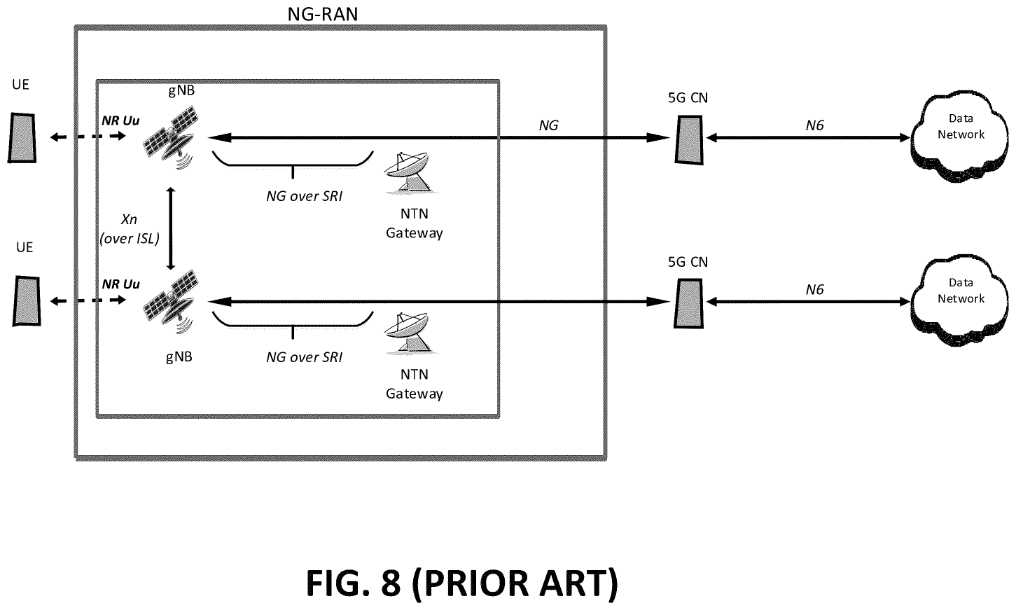

FIG. 8 is a reproduction of FIG. 5.2.1-2: Regenerative satellite with ISL, gNB processed payload, from 3GPP TR 38.821 V16.0.0.

The figure above illustrates that UE served by a gNB on board a satellite could access the 5GCN via ISL.

The gNB on board different satellites may be connected to the same 5GCN on the ground.

If the satellite hosts more than one gNB, the same SRI will transport all the corresponding NG interface instances.

5.2.2 gNB-DU Processed Payload

### 5.2.2.1 Overview

The NG-RAN logical architecture with CU/DU split as described in TS 38.401 is used as baseline for NTN scenarios.

The satellite payload implements regeneration of the signals received from Earth.
NR-Uu radio interface on the service link between the satellite and the UE.
Satellite Radio Interface (SRI) on the feeder link between the NTN gateway and the satellite. The SRI transports the F1 protocol.

The satellite payload may provide inter-satellite links between satellites.

SRI (Satellite Radio Interface) are transport links; the logical interface F1 that they transport are 3GPP-specified.

The NTN GW is a Transport Network Layer node, and supports all necessary transport protocols.

DU on board different satellites may be connected to the same CU on ground.

If the satellite hosts more than one DU, the same SRI will transport all the corresponding F1 interface instances.

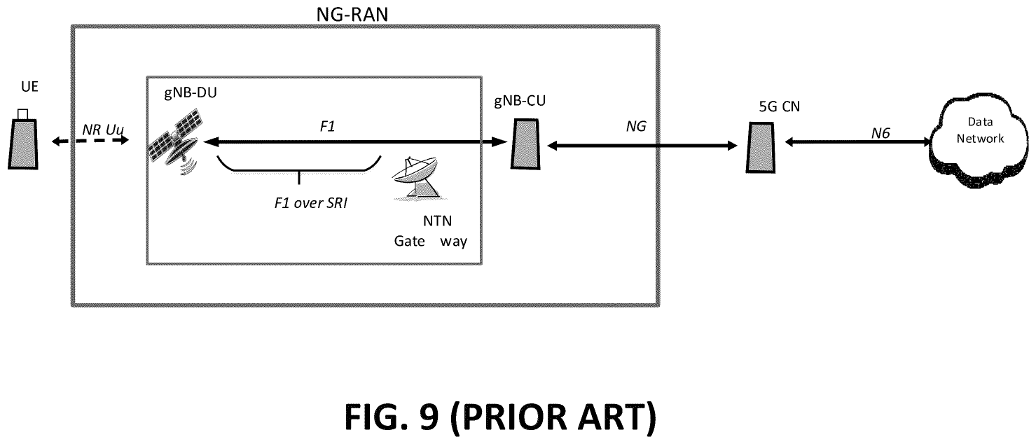

FIG. 9 is a reproduction of FIG. 5.2.2-1: NG-RAN with a regenerative satellite based on gNB-DU, from 3GPP TR 38.821 V16.0.0.

In 3GPP TR 22.865 ([2] 3GPP TR 22.865 V2.0.0), store & forward (S&F) operation is introduced. The S&F is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground segment.

More details including use cases and potential requirements for S&F operation are also specified in [2] 3GPP TR 22.865 V2.0.0:

### Annex a (Informative):

### Store and Forward Satellite Operation

The Store and Forward Satellite operation in a 5G system with satellite access is intended to provide some level of communication service for UEs under satellite coverage with intermittent/temporary satellite connectivity (e.g. when the satellite is not connected via a feeder link or via ISL to the ground network) for delay-tolerant communication service.

An example of “S&F Satellite operation” is illustrated in FIG. A-1, in contrast to what could be considered the current assumption for the “normal/default Satellite operation” of a 5G system with satellite access.

As shown in FIG. A-1:
Under “normal/default Satellite operation” mode, signalling and data traffic exchange between a UE with satellite access and the remote ground network requires the service and feeder links to be active simultaneously, so that, at the time that the UE interacts over the service link with the satellite, there is a continuous end-to-end connectivity path between the UE, the satellite and the ground network.
In contrast, under “S&F Satellite operation” mode, the end-to-end exchange of signalling/data traffic is now handled as a combination of two steps not concurrent in time (Step A and B in FIG. A-1). In Step A, signalling/data exchange between the UE and the satellite takes place, without the satellite being simultaneously connected to the ground network (i.e. the satellite is able to operate the service link without an active feeder link connection). In Step B, connectivity between the satellite and the ground network is established so that communication between the satellite and the ground network can take place. So, the satellite moves from being connected to the UE in step A to being connected to the ground network in step B.

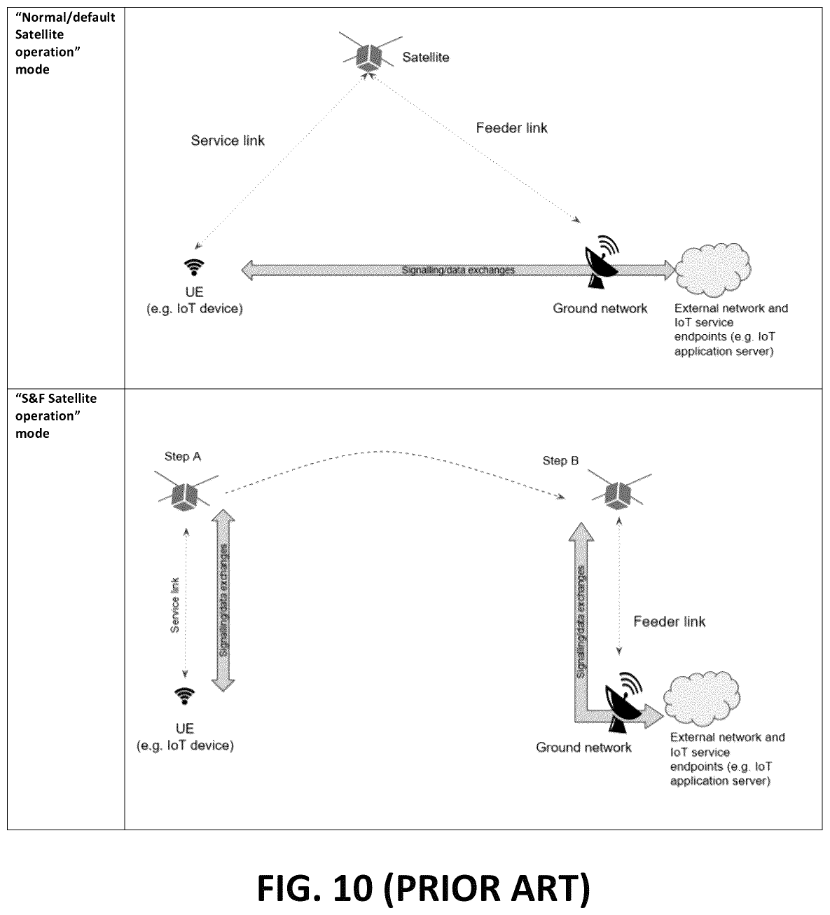

FIG. 10 is a reproduction of FIG. A-1: Illustration of “normal/default operation” and “S&F operation” modes in a 5G system with satellite access, from 3GPP TR 22.865 V2.0.0.

The concept of “S&F” service is widely used in the fields of delay-tolerant networking and disruption-tolerant networking. In 3GPP context, a service that could be assimilated to an S&F service is SMS, for which there is no need to have an end-to-end connectivity between the end-points (e.g. an end-point can be a UE and the other an application server) but only between the end-points and the SMSC which acts as an intermediate node in charge of storing and relying.

The support of S&F Satellite operation is especially suited for the delivery of delay-tolerant/non-real-time IoT satellite services with NGSO satellites.

### 5.1 Use Case on Store and Forward-MO

### 5.1.1 Description

This use case illustrates the realization of a S&F service between a UE with satellite access and an Application Server for a delay-tolerant/non-real-time IoT NTN service in the case of a Mobile Originated message.

A description of store and forward operation is provided in Annex A.

Company TrackingInc offers a service of remote monitoring of fields and deploys and tracks many battery-powered IoT type UEs across the globe. All the IoT remote monitoring UEs deployed include a 5G communication with satellite access. Some of the UEs are deployed in a remote area where there is no mobile coverage by MNO and only satellite is possible.

For the satellite access, TrackingInc uses the service of IoTSAT for the 5G IoT connectivity by satellite and IoTSAT uses a LEO constellation which supports S&F operation mode.

All IoT remote monitoring UEs regularly send information related to the area they are monitoring to the application server of TrackingInc and sometimes receive new parameters from the application server. In most of the cases, the messages exchanged are delay-tolerant/non-real-time IoT.

### 5.1.2 Pre-Conditions

In the present use case, the IoT remote monitoring UE is in a remote area with no ground stations available for feeder link connectivity and the IoT remote monitoring UE is aware that IoTSAT constellation operates in S&F mode.

### 5.1.3 Service Flows

The IoT remote monitoring UE needs to send a message to the TrackingInc application server. The UE waits for satellite network coverage and sends its message when the satellite passes by.

The IoT remote monitoring UE and the satellite providing coverage interact over the service link, allowing the UE to transfer the message to the satellite, which has no connectivity to the ground segment. And consequently, the satellite has to store locally the received message.

At this point:
1. Limitations to the size/amount of data that can be sent from the UE could be enforced.
2. Forwarding priority for the stored data to the ground station and data retention period for the exchanged data could be established.
3. Acknowledgement of the received data by the satellite could be issued.

At a later time, the satellite with the stored message establishes connectivity with the ground network via a feeder link and relays/forwards/downloads the message to the ground network. All accumulated and stored MO messages are delivered to the ground once the feeder link is available, at the same time, all accumulated and stored relevant MT messages are also delivered to the satellite via the same feeder link, which will impact the performance of the feeder link, 5GC, and satellite significantly. The relevant performance optimization method will be taken into consideration accordingly.

The ground network, based on established connectivity configuration and routing, delivers message to the TrackingInc application server.

### 5.1.4 Post-Conditions

The message generated by the IoT remote monitoring UE has been either delivered successfully to the TrackingInc application server without relying on a continuous end-to-end network connectivity path between them or, in case the data retention period has been exceeded, the message has been discarded.

### 5.2 Use Case on Store and Forward-MT

### 5.2.1 Description

This use case illustrates the realization of a S&F service between a UE with satellite access and an Application Server for a delay-tolerant/non-real-time IoT NTN service in the case of a Mobile Terminated message.

A description of store and forward operation is provided in Annex A.

Company TrackingInc offers a service of remote monitoring of fields and deploys and tracks many battery-powered IoT type UEs across the globe. All the IoT remote monitoring UEs deployed include a 5G communication with satellite access. Some of the UEs are deployed in a remote area where there is no mobile coverage by MNO and only satellite is possible.

For the satellite access, TrackingInc uses the service of IoTSAT for the 5G IoT connectivity by satellite and IoTSAT uses a LEO constellation which supports S&F operation mode.

All IoT remote monitoring UEs regularly send information related to the area they are monitoring to the application server of TrackingInc and sometimes receive new parameters from the application server. In most of the cases, the messages exchanged are delay-tolerant/non-real-time IoT.

### 5.2.2 Pre-Conditions

In the present use case, the IoT remote monitoring UE is in a remote area with no ground stations available for feeder link connectivity and the IoT remote monitoring UE is aware that IoTSAT constellation operates in S&F mode.

### 5.2.3 Service Flows

The TrackingInc application server needs to send new parameters to the IoT remote monitoring UE. Based on the information provided by the network, the application server is aware that the communication with UE is in S&F mode.

The TrackingInc application server message will send new parameters through dedicated messages by conventional means (e.g. IP routing, tunnels) to the network entry-point (e.g. a SCEF, PDN-GW, SMSC), and may provide additional information about the delivery priority, the acknowledgement, etc. to the network.

At this point:
4. Limitations on the amount of data to be transferred to the IoT remote monitoring UE could be enforced.
5. Forwarding priority to the UE could be established.
6. Acknowledgement of the received data by the network could be issued to the application server, possibly with the additional information about the store and forward, e.g. estimated time to deliver the messages.
7. End-to-end acknowledgement policy can be established.

The network stores the message until it can be delivered/relayed to a satellite expected to fly over and provide coverage to the destination IoT remote monitoring UE.

When the satellite is connected via the feeder link to the ground network, the message is uploaded into the satellite. All accumulated and stored MT messages are uploaded into the satellite via the feeder link. At the same time, all accumulated and stored MO messages are also delivered to 5GC via the same feeder link, which will cause a performance impact on the feeder link, satellite, and 5GC. It needs a performance optimization method here. When flying over the area that the IoT remote monitoring UE is located, the satellite with the stored message triggers paging over the service link for the UE to connect to the network. (How does the satellite knows where to page the UE (e.g., it has to associate a stored data to the location of the UE and its UE identity)? And what happen if UE moves?)

The stored message is delivered/downloaded from the satellite to the IoT remote monitoring UE. Acknowledgment may be requested/issued. Mechanisms to ensure integrity of the delivered information may be in place.

### 5.2.4 Post-Conditions

The message generated by the TrackingInc application server has been delivered successfully to the IoT remote monitoring UE without relying on a continuous end-to-end network connectivity path between them.

### 5.4 Use Case on Store and Forward-Data Transfer for IoT Devices in Remote Areas

### 5.4.1 Description

Data transfer at remote sites is a very common requirement. Research institutions can obtain data from remote sites for scientific research, e.g. animal tracking [5]. Government agencies can obtain data from remote sites for disaster mitigation and avoidance, e.g. via remote sensing [6]. Commercial companies can obtain data from remote sites for proper resource allocation. Data transmission at many remote sites is delay-insensitive, and satellite coverage does not always ensure that satellites connect to both the service link and the feeder link. In the past 30 years, many scholars have devoted themselves to studying the data transmission problem of remote sites, and developed the store and forward mechanisms to solve the problem [7] [8] [9].

In remote areas, there is no terrestrial network for various reasons, e.g. it is difficult to build and maintain communication towers. As a result, this makes it challenging to collect information for environmental protection purposes in these areas. For example, sensors installed on animals need to be monitored regularly. In this scenario, the sensors installed on the animals send the status information, e.g. the movements, physiology and surrounding environment of the animals, to the satellite; and the satellite stores the received status information of the animals, and forwards the information to the scientific centre when a feeder link becomes available.

### 5.4.2 Pre-Conditions

EA Science Center has installed sensors (IoT devices) on the animals to collect information for environmental protection purposes in these remote areas. Satelles, the satellite communication operator, has launched the Store & Forward Satellite operation to support the data transferring for the remote areas. EA Science Center has signed contract with Satelles to allow sensors installed on animals to send the status information (e.g. the movements, physiology and surrounding environment of the animals) to the Science Center via satellite.

The satellite and the IoT devices are properly configured with sufficient information, e.g. credential/certificate that is needed for the devices to verify the authenticity of the satellite.

### 5.4.3 Service Flows

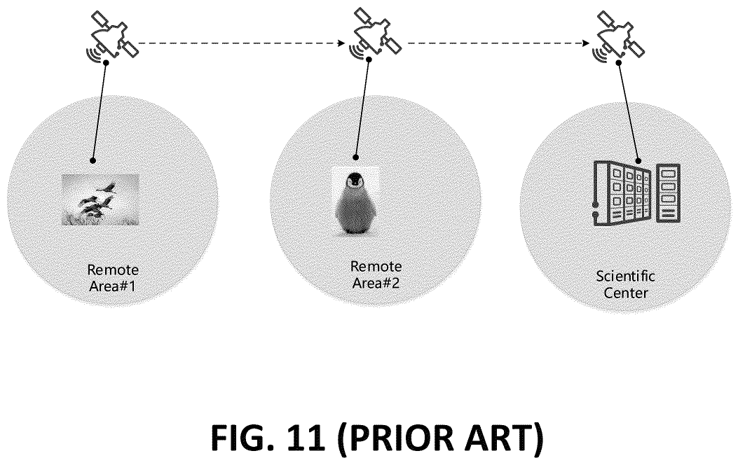

FIG. 11 is a reproduction of FIG. 5.4.3-1: Animal tracking in the remote areas, from 3GPP TR 22.865 V2.0.0.
1. The IoT devices are installed on animals and powered on, they are registered with the 5G network for the Store & Forward Satellite operation. The satellite with the store and forward function enables the IoT devices to transfer data to the network, even when the feeder link to the ground is not available. A secured connection between an IoT device and the satellite is established to protect the data security and privacy.
2. The IoT devices send sensor status information to the satellite, the satellite stores the sensor status information received from the IoT devices.
3. When the satellite has the feeder link available to the ground segment, the satellite forwards the sensor status information, as well as other necessary information, to the ground core network. The ground core network verifies the IoT devices based on the information received; if it is allowed, the ground core network forwards the sensor status information to its destination data network.
4. The ground core network sends the result of the operation to the satellite (the same satellite or a different one that will pass through the remote area).
5. When the satellite (or next satellite) passes through the remote area, the satellite pages the UE, and based on the result received from ground core network, the satellite sends result of the operation to the IoT devices.
6. If an IoT device needs to update the sensor status information, it can send it to the satellite when it is connected to the satellite. The satellite stores it and forwards the sensor status information to the ground core network when feeder link becomes available.

### 5.4.4 Post-Conditions

After the scientific centre receives the sensor status information, the scientists can analyse the sensor status information, and track the status of the animals.

### 5.16 Use Case on Store and Forward-Emergency Report

### 5.16.1 Description

This use case illustrates the realization of a S&F service between a UE with satellite access and an Application Server for an emergency reporting service.

A description of store and forward operation is provided in Annex A.

Bob was sailing on an intercontinental containership, which sank for some exotic reason. Bob is now shipwrecked on a remote island and while he is not in immediate danger, he needs rescue within a matter of days as food and water is scarce.

A few items from the containership washed ashore with Bob, one of which is an IoT device from Company TrackingInc with a subscription to IoTSAT for the 5G IoT connectivity by satellite and IoTSAT is using a LEO constellation which supports S&F operation mode.

The IoT device allows Bob to send an emergency report including his position via the S&F network. A confirmation is received by the IoT device that the emergency report “went through” as soon as possible. As the indicator light by the emergency button of the IoT device starts blinking green, Bob knows that it is a matter of time before Alice rescues him.

### 5.16.2 Pre-Conditions

In the present use case, the emergency reporting UE is in a remote area with no ground stations available for feeder link connectivity and the emergency reporting UE is aware that IoTSAT constellation operates in S&F mode.

### 5.16.3 Service Flows

1. Bob is sailing on an intercontinental containership, which sinks.
2. Bob is ashore and finds an IoT device from Company TrackingInc with a subscription to IoTSAT for the 5G IoT connectivity by satellite.
3. Bob sends an emergency report including his position with the IoT device from Company TrackingInc through IoTSAT.
4. The emergency report from Bob is received by the fly-by satellite of the IoTSAT constellation and is stored in the satellite waiting to be delivered as there is no feeder link available in the area where Bob is ashore.
5. The satellite of the IoTSAT constellation is able to deliver the “emergency report” from Bob in a matter of seconds as soon as a first feeder link is available as it identified the service as emergency and there is no restriction to use any feeder link and ground station for such service.
6. Bob is informed that the emergency report has been delivered upon the next fly-by of a satellite from the IoTSAT constellation.

### 5.16.4 Post-Conditions

The emergency report generated by the IoT UE has been delivered successfully to the TrackingInc application server and forwarded to a service able to treat the report and a response has been forwarded to the IoT UE without relying on a continuous end-to-end network connectivity path between them.

### 6.2 Store & Forward Satellite Operation

The potential requirements corresponding to the support of Store & Forward Satellite information are listed in the table below.

TABLE 6.2-1
Consolidated Requirements for Store & Forward Satellite operation

| | Consolidated Potential | | |
|---|---|---|---|
| CPR # | Requirement | Original PR # | Comment |
| CPR 6.2-1 | Subject to operator's | [PR 5.1.6-001] | |
| | policies, a 5G system with | [PR.5.3.6-001] | |
| | satellite access shall be | [PR 5.4.6-001] | |
| | able to support Store & | | |
| | Forward Satellite operation | | |
| | for authorized UEs e.g. | | |
| | store data on the satellite | | |
| | when the feeder link is | | |
| | unavailable; and forward | | |
| | the data when feeder link | | |
| | between the satellite and | | |
| | the ground segment is | | |
| | available. | | |
| CPR 6.2-2 | A 5G system with satellite | [PR 5.1.6-002] | |
| | access shall be able to | | |
| | inform a UE whether | | |
| | Store & Forward Satellite | | |
| | operation is applied. | | |
| CPR 6.2-3 | Subject to operator's | [PR 5.1.6-003] | |
| | policies, a 5G system with | [PR 5.2.6-002] | |
| | satellite access supporting | | |
| | Store & Forward Satellite | | |
| | operation shall be able | | |
| | to allow the operator or a | | |
| | trusted 3rd party to apply, | | |
| | on a per UE and/or satellite | | |
| | basis, an S&F data | | |
| | retention period. | | |
| CPR 6.2-4 | Subject to operator's | [PR 5.1.6-004] | |
| | policies, a 5G system with | [PR 5.2.6-003] | |
| | satellite access supporting | [PR.5.3.6-003] | |
| | Store & Forward Satellite | [PR 5.4.6-004] | |
| | operation shall be able | | |
| | to allow the operator or a | | |
| | trusted 3rd party to apply, | | |
| | on a per UE and/or satellite | | |
| | basis, an S&F data | | |
| | storage quota. | | |
| CPR 6.2-5 | A 5G system with satellite | [PR 5.1.6-005] | |
| | access supporting Store & | [PR 5.2.6-004] | |
| | Forward Satellite operation | | |
| | shall be able to support a | | |
| | mechanism to configure | | |
| | and provision specific | | |
| | required QoS and policies | | |
| | for UE's data subject to | | |
| | store and forward operation | | |
| | (e.g. forwarding priority, | | |
| | acknowledgment policy). | | |
| CPR 6.2-6 | A 5G system with satellite | [PR.5.16.6-001] | |
| | access supporting Store & | | |
| | Forward Satellite operation | | |
| | shall be able to inform an | | |
| | authorized UE about how | | |
| | long the data received from | | |
| | the UE is expected to | | |
| | be stored before being | | |
| | delivered. | | |
| CPR 6.2-7 | A 5G system with satellite | [PR 5.2.6-001] | Missing |
| | access shall be able to | [PR 5.2.6-005] | similar |
| | inform an authorised | | mention |
| | 3^{rd} party whether Store & | | of the |
| | Forward Satellite | | estimated |
| | operation is applied for | | delivery |
| | communication with a UE | | time for MO |
| | and to provide information | | use case (in |
| | associated (e.g. estimated | | CPR 6.2-6) |
| | delivery time to the UE). | | |

In [4] 3GPP RWS-230178, it is specified that on top of discontinuous coverage, there could also be intermittent feeder link (FL) connectivity with the ground station (GS) in areas where it is not feasible to deploy a ground station or where deployment of ground station is not cost effective. A potential call flow for intermittent feeder link is specified:

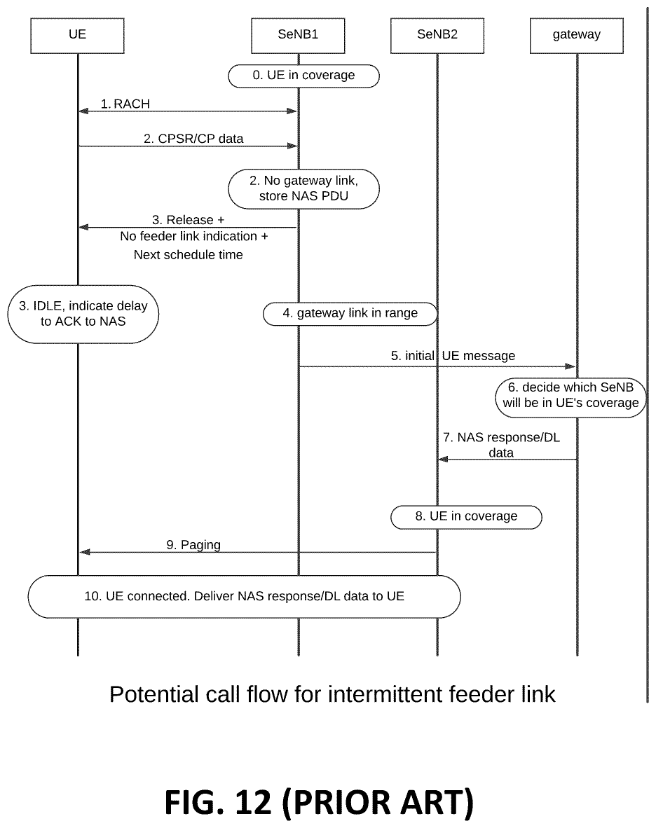

FIG. 12 is a reproduction of a potential call flow for intermittent feeder link figure, from 3GPP RWS-230178.

In 3GPP TS 23.501 ([3] 3GPP TS 23.501 V18.1.0), 5G system architecture is illustrated:

### 4.2.3 Non-Roaming Reference Architecture

FIG. 4.2.3-1 depicts the non-roaming reference architecture. Service-based interfaces are used within the Control Plane.

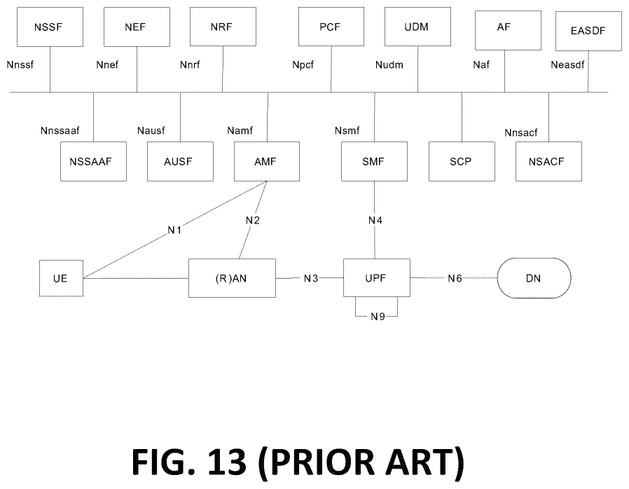

FIG. 13 is a reproduction of FIG. 4.2.3-1: Non-Roaming 5G System Architecture, from 3GPP TS 23.501 V18.1.0.

A Non-Terrestrial Network (NTN) is a network which provides non-terrestrial access to User Equipment (UE), e.g., by means of an NTN payload embarked on an airborne or space-borne NTN vehicle and an NTN Gateway. NTN may comprise one or more network nodes, such as Next Generation Radio Access Network (NG-RAN) node or Next Generation Node B/New Radio (NR) Node B (gNB). The UE may link to, camp on, and/or connect to the NTN network for transmission and/or reception.

The NTN may comprise various platforms, including low earth orbit (LEO) satellite, medium earth orbit (MEO) satellite, highly elliptical orbit (HEO) satellite, geostationary earth orbit (GEO) satellite, geostationary synchronous Orbit (GSO) satellite, non-geostationary synchronous orbit (NGSO) satellite, and/or high altitude platform station (HAPS). A LEO satellite could have earth-fixed beam (e.g., the beam is temporarily fixed on a location during a time period) or earth-moving beam (e.g., the beam is continuously moving along with the satellite). A LEO satellite could serve/provide earth moving cells (e.g., with earth-fixed beam) and/or (quasi-) earth fixed cells (e.g., with earth-moving beam).

The NTN could offer a wide-area coverage and provide Network (NW) access in the scenario when Terrestrial Networks (TN) is unfeasible (e.g., desert, polar area, and/or on an airplane). More details regarding different NTN platforms could be found in TR 38.821 (e.g., [1] 3GPP TR 38.821 V16.0.0).

Store and Forward (S&F) operation could be considered as an operation mode of satellite-access providing some level of service (in storing and forwarding the data) when satellite connectivity is intermittently/temporarily unavailable, e.g., to provide communication service for UEs under satellite coverage without a simultaneous active feeder link connection to the ground segment.

The network supporting S&F operation may be based on architecture of regenerative payload (e.g., as specified in TR 38.821 (e.g., [1] 3GPP TR 38.821 V16.0.0)). The network may comprise a Radio Access Network (RAN) and/or a Core Network (CN). The RAN may comprise one or more RAN node(s). The CN may comprise one or more CN node(s). The RAN (or RAN node) may be (or comprise) an NG-RAN node, a gNB, a gNB-Distributed Unit (DU), a gNB-Central Unit (CU), an Evolved Universal Terrestrial Radio Access Network (E-UTRAN) node, an Evolved Node B (eNB), and/or a base station. The CN (or CN node) may be (or comprise) an Evolved Packet Core (EPC), a Mobility Management Entity (MME), a Serving Gateway (S-GW), a 5G Core (5GC), a User Plane Function (UPF), an Access and Mobility Management Function (AMF), a Session Management Function (SMF), and/or a network node specified in TS 23.501 (e.g., [3] 3GPP TS 23.501 V18.1.0).

The network (e.g., 5G system) may be separated into two parts. One part of the network, comprising one or more network node(s) or network segment(s), is located on a satellite. The other part of the network, comprising one or more network node(s) or network segment(s), which is not located on a satellite, is located on the ground. The network node(s) and/or network segment(s) may be one or more network nodes (e.g., RAN node or CN node) and/or a portion and/or a combination of the network node(s) mentioned or not mentioned above. For simplicity, the network, network node(s), and/or network segment(s) located or deployed in a satellite (or the related network such as what mentioned above) may be referred as the NW on satellite (or satellite NW). The network, network node(s), and/or network segment(s) located or deployed on the ground (or the related network such as what is mentioned above) may be referred to as a NW on ground (or ground NW).

For example, the satellite NW may be (or comprise) a RAN (e.g., NG-RAN, gNB, and/or eNB). The ground NW may be (or comprise) a CN (e.g., EPC, 5GC, MME, S-GW, AMF, and/or UPF). For example, the satellite NW may be (or comprise) a gNB-DU. The ground NW may be (or comprise) a gNB-CU and/or one or more CN nodes (e.g., AMF, UPF). For example, the satellite NW may be (or comprise) a RAN (e.g., NG-RAN, gNB, and/or eNB) and/or one or more CN nodes (or segments) (e.g., AMF, UPF, MME, S-GW). The ground NW may be the other one or more CN nodes (or segments) (e.g., excluding the part of the satellite NW). For example, the satellite NW may be (or comprise) a first part of an MME (e.g., on the satellite). The ground NW may be (or comprise) a second part of the MME (e.g., on the ground). The first part of the MME and the second part of the MME may be different. The first part and the second part of the MME may be mutually exclusive.

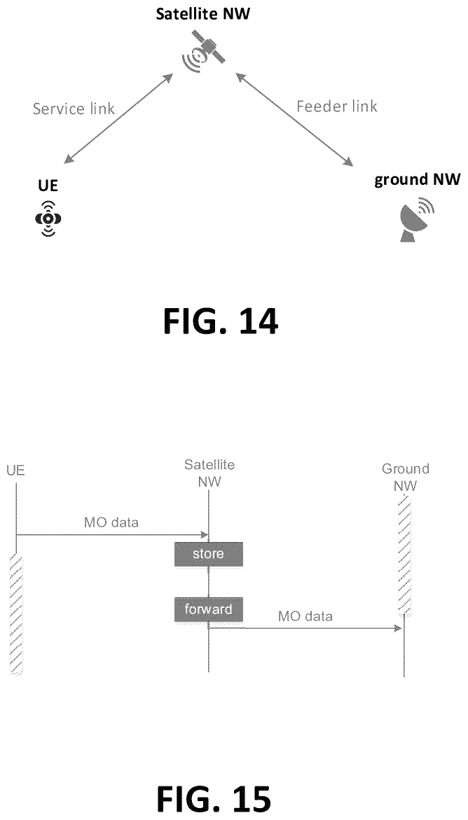

The link/connection/interface between the satellite NW and the ground NW may be referred to as a feeder link. The link/connection/interface between the satellite NW and a UE may be referred to as a service link. An example is shown in FIG. 14.

A UE and/or a network node (e.g., a first network node, a satellite NW) may be in S&F mode (or using S&F operation) if at least one or more of the following conditions are fulfilled:
The feeder link (of the UE and/or the network node) is not available; and/or
An indication of S&F mode (and/or to enable S&F mode) is received (or transmitted); and/or
A configuration related to S&F mode (and/or enabled) is received (or transmitted); and/or
S&F mode (of the UE and/or the network node) is enabled and/or activated.

The UE and/or the network node (e.g., a first network node, a satellite NW) may be in normal mode (e.g., compared to S&F mode) if at least one or more of the following conditions are fulfilled:
The feeder link (of the UE and/or the network node) is available; and/or
No indication of S&F mode is received (or transmitted); and/or
An indication to disable (or deactivate) S&F mode is received (or transmitted); and/or
No configuration related to S&F mode (and/or enabled) is received (or transmitted); and/or
A configuration to disable (or deactivate) S&F mode is received (or transmitted); and/or
S&F mode (of the UE and/or the network node) is disabled and/or deactivated.

The UE and/or the network node may enter S&F mode from normal mode, and/or leave S&F mode to enter normal mode.

When the UE and/or the network node (e.g., a first network node, a satellite NW) is in S&F mode (or using S&F operation), at least one or more of the following may be performed:
The UE may know (or be informed by NW) that the NW is (or starts) using S&F to handle data (and/or signaling); and/or
The UE may initiate a procedure to request (or indicate) the (satellite) NW to use S&F to handle data (and/or signaling); and/or
The UE may perform data (and/or signaling) transmission that will be handled by S&F in the (satellite) NW; and/or
The UE may (be ready to) perform data (and/or signaling) reception that is stored in the (satellite) NW.

For User Plane (UP) data, the data could be stored in the satellite NW for a while, and then forward to the ground NW when the feeder link between the satellite NW and the ground NW is available. An example is shown in FIG. 15.

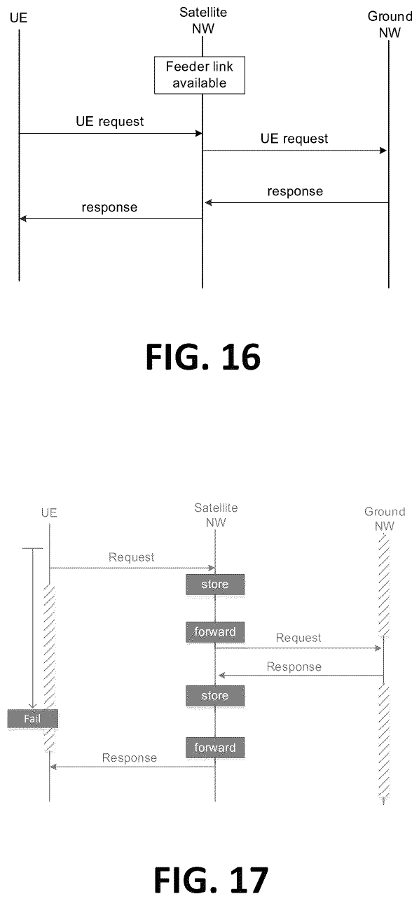

For some Control Plane (CP) procedure (e.g., involves request and response) and/or UP transmission (e.g., involves transmission and acknowledgement, where the ground NW is involved), the response (or acknowledgement) of the procedure and/or transmission is generated by the ground NW (e.g., in normal mode, compared to S&F mode), as shown in FIG. 16. However, when a satellite NW is operating in S&F mode and/or the feeder link of the satellite NW is not available, the satellite NW is unable to communicate with the ground NW (at least temporarily). The procedure and/or the transmission may result in failure (e.g., due to expiry/expiration of a timer to control the duration of the procedure and/or the transmission, as shown in FIG. 17. Therefore, the procedure and/or the transmission may not be performed (or completed) as in the legacy manner (e.g., in normal mode). This may be due to the ground NW needing to process/handle/respond to something (e.g., response, acknowledgement) in the procedure and/or the transmission while the ground NW is not reachable for the moment. It is not clear how the procedure and/or the transmission is handled in S&F mode (or using S&F operation).

For example, a UE may initiate a registration (or attach) procedure and transmit a registration (or attach) request to a network, e.g., for initial registration (or attach), for periodic registration, and/or for mobility registration. Normally (e.g., in normal mode) the response message (e.g., registration or attach accept or reject) is generated by a CN node (e.g., MME, AMF). If the CN node is located on the ground and not reachable when the feeder link is not available, it is not clear how the satellite NW handles the UE request in response to the request.

For example, a UE may initiate a service request procedure and transmit a service request to the network, e.g., for initiating a new service, for updating a service, and/or for terminating a service. Normally (e.g., in normal mode) the response message (e.g., service accept or reject) is generated by a CN node (e.g., MME, AMF). If the CN node is located on the ground and not reachable when the feeder link is not available, it is not clear how the satellite NW handles the UE request in response to the request.

For example, a UE may initiate a Mobile Originated (MO) Short Message Service (SMS) to the NW. The UE may transmit a Transfer Protocol Data Unit (TPDU) to the NW. The UE may transmit a Relay Protocol (RP)-DATA message to the NW. The UE may start a timer (e.g., TR1*) in response to the transmission (e.g., MO SMS, TPDU, RP-DATA). The UE may expect to receive a response of the transmission (e.g., acknowledgement, RP-Acknowledgement (ACK)) before expiry of the timer. The UE may consider the transmission as failed upon expiry of the timer. The UE may abort the transmission upon expiry of the timer. When the satellite NW is in S&F mode or the feeder link of the satellite NW is not available, the NW may not be able to respond to the transmission in time (e.g., before the timer expiry).

To solve the issue, a UE may not be allowed to initiate (or perform) at least a procedure and/or transmission in S&F mode (or using S&F operation, or when the feeder link is not available). The procedure and/or transmission may involve (or be related to, or is associated to) at least a network node (or segment) of the ground NW (e.g., a response message or an accept message of the procedure and/or transmission is generated by the ground NW). The UE may be allowed to initiate (or perform) at least the procedure and/or transmission in normal mode (and/or not in S&F mode).

The UE may determine whether to initiate (or perform) a procedure (or transmission) based on (at least) one or more of the following conditions:
Operation mode; and/or
   For example, if (or when) the UE is in S&F mode (or using S&F operation).
   For example, if (or when) the UE can only use S&F operation (e.g., for transmission).
   For example, if (or when) the NW (e.g., the satellite NW, the serving cell) is in S&F. mode (or using S&F operation).
Feeder link (or ground NW) availability; and/or
   For example, if (or when) the feeder link (or the UE, the serving cell, and/or the NW) is available.
   For example, if (or when) the ground NW is reachable.
Characteristic of the procedure (or transmission); and/or
   For example, if (or when) the procedure (or transmission) is related to ground NW.
   For example, if (or when) the ground NW is involved in the procedure (e.g., a response message or an accept message is generated by the ground NW).
Service associated with the procedure (or transmission); and/or
   For example, if (or when) a service associated with the procedure can be served (e.g., in S&F mode).
   For example, if (or when) requirement of a service (associated with the procedure) can be fulfilled (e.g., in S&F mode).
Purpose of the procedure; and/or
   For example, if (or when) the purpose is for establishment (e.g., a connection, a registration, a service).
   For example, if (or when) the purpose is for modification (e.g., a connection, a registration, a service).
   For example, if (or when) the purpose is for release (e.g., a connection, a registration, a service).
   For example, if (or when) the purpose is for initialization (e.g., a connection, a registration, a service).
   For example, if (or when) the purpose is for periodic update (e.g., a connection, a registration, a service).
   For example, if (or when) the purpose is for mobility update (e.g., a connection, a registration, a service).
Status of the UE.
   For example, if (or when) the UE is (or has been) authenticated, authorized, and/or registered.
   For example, if (or when) the UE is (or has been) connected to the network (e.g., the ground NW).
   For example, if (or when) the UE is (or has been) in a connected state.

The UE may be not allowed to initiate (or perform) the procedure (or transmission) if/when/in response to/based on at least one or more condition(s) is fulfilled. The UE may be prohibited to initiate (or perform) the procedure (or transmission) if/when/in response to/based on at least one or more condition(s) is fulfilled. The UE may not initiate (or perform) the procedure (or transmission) if/when/in response to/based on at least one or more condition(s) is fulfilled. The UE may be allowed to initiate (or perform) the procedure (or transmission) if/when/in response to/based on at least one or more condition(s) is not fulfilled. The UE may not be prohibited to initiate (or perform) the procedure (or transmission) if/when/in response to/based on at least one or more condition(s) is not fulfilled. The UE may initiate (or perform) the procedure (or transmission) if/when/in response to/based on at least one or more condition(s) is not fulfilled.

The UE may be not allowed to initiate (or perform) the procedure (or transmission) if/when/in response to/based on at least one or more condition(s) is not fulfilled. The UE may be prohibited to initiate (or perform) the procedure (or transmission) if/when/in response to/based on at least one or more condition(s) is not fulfilled. The UE may not initiate (or perform) the procedure (or transmission) if/when/in response to/based on at least one or more condition(s) is not fulfilled. The UE may be allowed to initiate (or perform) the procedure (or transmission) if/when/in response to/based on at least one or more condition(s) is fulfilled. The UE may not be prohibited to initiate (or perform) the procedure (or transmission) if/when/in response to/based on at least one or more condition(s) is fulfilled. The UE may initiate (or perform) the procedure (or transmission) if/when/in response to/based on at least one or more condition(s) is fulfilled.

If the UE intends (or needs) to initiate (or perform) the procedure (or transmission) but it is prohibited (or not allowed) due to at least one or more condition(s) mentioned above (e.g., the at least one or more condition(s) is fulfilled), the UE may initiate (or perform) the procedure (or transmission) when the at least one or more condition(s) becomes not fulfilled.

If the UE intends (or needs) to initiate (or perform) the procedure (or transmission) but it is prohibited (or not allowed) due to at least one or more condition(s) mentioned above (e.g., the at least one or more condition(s) is not fulfilled), the UE may initiate (or perform) the procedure (or transmission) when the at least one or more condition(s) becomes fulfilled.

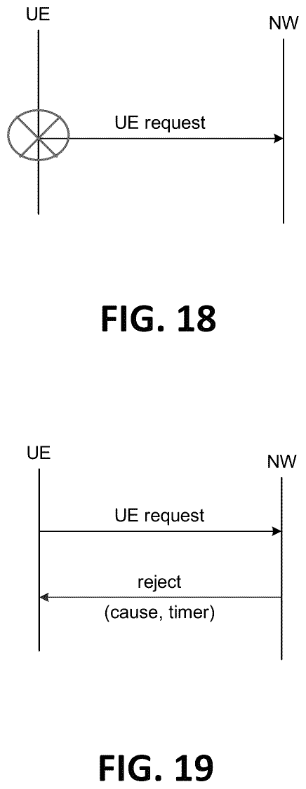

In one or more examples, a UE may (determine whether to) initiate a first procedure based on whether the UE is in S&F mode and/or whether the feeder link is available. If the UE is in S&F mode (or the feeder link is not available), the UE is not allowed to initiate a first procedure. If the UE is in normal mode (e.g., not in S&F mode, or the feeder link is available), the UE is allowed to initiate a first procedure. An example is shown in FIG. 18.

The UE may be allowed to initiate (or perform) a second procedure when the UE is in S&F mode (or the feeder link is not available).

The UE may be allowed to initiate a third procedure regardless of whether it is in S&F mode (or whether the feeder link is available).

The first procedure, the second procedure, and/or the third procedure may be different procedures. The first procedure, the second procedure, and/or the third procedure may be the same procedure with different purposes (or causes). The same procedure with a different purpose (or cause) may be considered as a different procedure here.

A different procedure (or transmission) may be handled differently.

To solve the issue, a network node (e.g., the satellite NW) may reject (or not accept) a request of at least a procedure (or a transmission) from a UE if (at least) the network node is in S&F mode (or using S&F operation). The procedure and/or transmission may involve (or be related to, or is associated to) at least a network node (or segment) of the ground NW (e.g., a response message or an accept message of the procedure and/or transmission is generated by the ground NW).

The UE may transmit a request of at least a procedure to the network node. The network node (e.g., the satellite NW) may (determine whether to) reject (or accept) the request of at least the procedure (or transmission) from a UE based on (at least) one or more of the following conditions:
Operation mode; and/or
   For example, if (or when) the UE is in S&F mode (or using S&F operation).
   For example, if (or when) the UE can only use S&F operation (e.g., for transmission).
   For example, if (or when) the NW (e.g., the satellite NW, the serving cell) is in S&F mode (or using S&F operation).
Feeder link or ground NW availability; and/or
   For example, if (or when) the feeder link (or the UE, the serving cell, and/or the NW) is available.
   For example, if (or when) the ground NW is reachable.
Characteristic of the procedure (or transmission); and/or
   For example, if (or when) the procedure (or transmission) is related to ground NW.
   For example, if (or when) the ground NW is involved in the procedure (e.g., a response message or an accept message is generated by the ground NW).
Service associated with the procedure (or transmission); and/or
   For example, if (or when) a service associated with the procedure can be served (e.g., in S&F mode).
   For example, if (or when) requirement of a service (associated with the procedure) can be fulfilled (e.g., in S&F mode).
Purpose of the procedure; and/or
   For example, if (or when) the purpose is for establishment (e.g., a connection, a registration, a service).
   For example, if (or when) the purpose is for modification (e.g., a connection, a registration, a service).
   For example, if (or when) the purpose is for release (e.g., a connection, a registration, a service).
   For example, if (or when) the purpose is for initialization (e.g., a connection, a registration, a service).
   For example, if (or when) the purpose is for periodic update (e.g., a connection, a registration, a service).
   For example, if (or when) the purpose is for mobility update (e.g., a connection, a registration, a service).
Status of the UE; and/or
   For example, if (or when) the UE is (or has been) authenticated, authorized, and/or registered.
   For example, if (or when) the UE is (or has been) connected to the network (e.g., the ground NW).
   For example, if (or when) the UE is (or has been) in a connected state.
Configuration or indication.
   For example, if (or when) a configuration or indication, e.g., from ground NW, is received.
   For example, if (or when) the network node has a (local or stored) configuration (e.g., for responding or accepting the procedure).
   For example, if (or when) the network node is configured by the ground NW, e.g., to handle/process/respond to the procedure.

The network node (e.g., the satellite NW) may reject (or not accept) the request of the procedure (or the transmission) from the UE if/when/in response to/based on at least one or more condition(s) is fulfilled. The network node (e.g., the satellite NW) may accept the request of the procedure (or the transmission) from the UE if/when/in response to/based on at least one or more condition(s) is not fulfilled.

The network node (e.g., the satellite NW) may reject (or not accept) the request of the procedure (or the transmission) from the UE if/when/in response to/based on at least one or more condition(s) is not fulfilled. The network node (e.g., the satellite NW) may accept the request of the procedure (or the transmission) from the UE if/when/in response to/based on at least one or more condition(s) is fulfilled.

The network node (e.g., the satellite NW) may receive a configuration and/or an indication from the ground NW, e.g., when feeder link is available. The configuration and/or the indication may configure and/or indicate (whether) to reject a request of the procedure from the UE.

The network node (e.g., the satellite NW) may transmit a response message to the UE, e.g., in response to the request of the procedure from the UE. The response message may be a reject message or an accept message. The response message may include a cause value, e.g., a reject cause. The cause value may be (or related to, or associated to) S&F mode (or S&F operation), and/or feeder link not available.

The response message may include a value of a timer. The timer may be a wait timer. The value may indicate (or used to derive) the time that the feeder link is (expected to be) available (or the ground NW is reachable). The UE may start a timer (e.g., the wait timer) with the value set to the value included in the response message, e.g., in response to or upon receiving the response message. The UE may transmit (or retransmit) the request if/upon/in response to the timer expiry. The UE may transmit (or retransmit) the request if/upon/in response to the UE detecting that the feeder link becomes available (or the ground NW becomes reachable).

In one or more examples, the network node may receive a request of a first procedure from a UE. The network node may reject the request if the network node is in S&F mode (or using S&F operation, or the feeder link of the network node is not available). The network node may transmit a response message to the UE to reject the request. An example is shown in FIG. 19.

The network node may not reject a request of a second procedure from a UE based on (or due to) S&F mode (or operation) and/or feeder link available.

The first procedure and the second procedure may be different procedures. The first procedure and the second procedure may be the same procedure with different purposes (or causes). The same procedure with different purpose (or cause) may be considered as a different procedure here.

A different procedure (or transmission) may be handled differently.

To solve the issue, a network node (e.g., the satellite NW) may (temporarily) suspend (a request of) at least a procedure (or a transmission) from a UE if (at least) the network node is in S&F mode (or using S&F operation). The procedure and/or transmission may involve (or be related to, or is associated to) at least a network node (or segment) of the ground NW (e.g., a response message or an accept message of the procedure and/or transmission is generated by the ground NW). The network node (e.g., the satellite NW) may resume or continue (the request of) the procedure if (at least) the network node is not in S&F mode (or not using S&F operation), e.g., enters normal mode.

The UE may transmit a request of at least a procedure to the network node. The network node (e.g., the satellite NW) may (determine whether to) suspend (a request of) at least the procedure (or transmission) from a UE based on (at least) one or more of the following conditions:
Operation mode; and/or
   For example, if (or when) the UE is in S&F mode (or using S&F operation).
   For example, if (or when) the UE can only use S&F operation (e.g., for transmission).
   For example, if (or when) the NW (e.g., the satellite NW, the serving cell) is in S&F mode (or using S&F operation).
Feeder link or ground NW availability; and/or
   For example, if (or when) the feeder link (or the UE, the serving cell, and/or the NW) is available.
   For example, if (or when) the ground NW is reachable.
Characteristic of the procedure (or transmission); and/or
   For example, if (or when) the procedure (or transmission) is related to ground NW.
   For example, if (or when) the ground NW is involved in the procedure (e.g., a response message or an accept message is generated by the ground NW).
Service associated with the procedure (or transmission); and/or
   For example, if (or when) a service associated with the procedure can be served (e.g., in S&F mode).
   For example, if (or when) requirement of a service (associated with the procedure) can be fulfilled (e.g., in S&F mode).
Purpose of the procedure; and/or
   For example, if (or when) the purpose is for establishment (e.g., a connection, a registration, a service).
   For example, if (or when) the purpose is for modification (e.g., a connection, a registration, a service).
   For example, if (or when) the purpose is for release (e.g., a connection, a registration, a service).
   For example, if (or when) the purpose is for initialization (e.g., a connection, a registration, a service).
   For example, if (or when) the purpose is for periodic update (e.g., a connection, a registration, a service).
   For example, if (or when) the purpose is for mobility update (e.g., a connection, a registration, a service).
Status of the UE; and/or
   For example, if (or when) the UE is (or has been) authenticated, authorized, and/or registered.
   For example, if (or when) the UE is (or has been) connected to the network (e.g., the ground NW).
   For example, if (or when) the UE is (or has been) in a connected state.
Configuration or indication.
   For example, if (or when) a configuration or indication, e.g., from ground NW, is received.
   For example, if (or when) the network node has a (local or stored) configuration (e.g., for responding or accepting the procedure).
   For example, if (or when) the network node is configured by the ground NW, e.g., to handle/process/respond to the procedure.

The network node (e.g., the satellite NW) may suspend (the request of) the procedure (or the transmission) from the UE if/when/in response to/based on at least one or more condition(s) is fulfilled. The network node (e.g., the satellite NW) may not suspend (the request of) the procedure (or the transmission) from the UE if/when/in response to/based on at least one or more condition(s) is not fulfilled. The network node (e.g., the satellite NW) may resume (the request of) the procedure (or the transmission) if/when/in response to/based on at least one or more condition(s) is not fulfilled.

The network node (e.g., the satellite NW) may suspend (the request of) the procedure (or the transmission) from the UE if/when/in response to/based on at least one or more condition(s) is not fulfilled. The network node (e.g., the satellite NW) may not suspend (the request of) the procedure (or the transmission) from the UE if at least one or more condition(s) is fulfilled. The network node (e.g., the satellite NW) may resume (the request of) the procedure (or the transmission) if at least one or more condition(s) is fulfilled.

The network node (e.g., the satellite NW) may receive a configuration and/or an indication from the ground NW, e.g., when the feeder link is available. The configuration and/or the indication may configure and/or indicate (whether) to suspend (a request of) the procedure. The configuration may indicate (or be used to derive) how long the request and/or the procedure is (expected to be) suspended.

The network node (e.g., the satellite NW) may transmit a response message to the UE, e.g., in response to the request of the procedure from the UE. The response message may indicate that the procedure and/or the request is suspended. The response message may include a cause value. The cause value may be (or related to, or associated to) S&F mode (or S&F operation), and/or the feeder link not available. The UE may consider the procedure as suspended in response to (or upon) receiving the response message.

The response message may include a value of a first timer. The first timer may be a wait timer. The value may indicate (or used to derive) the time that the feeder link is (expected to be) available (or the ground NW is reachable). The value may or may not be zero. The UE may start a first timer (e.g., the wait timer) with the value set to the value included in the response message, e.g., in response to (or upon) receiving the response message. The UE may consider the procedure as suspended during/when the first timer is running. The UE may consider the procedure as suspended if/when/in response to receiving the response message (and/or the value of the first timer). The UE may consider the procedure as resumed if/when/upon/in response to expiry of the first timer. The UE may re-initiate the procedure or retransmit the request if/when/upon/in response to expiry of the first timer.

The UE may receive another message to terminate (or reject) the procedure, e.g., when the first timer is running. The UE may terminate the procedure and/or consider the procedure as failed (or rejected) in response to receiving the message.

The response message may include a value of a second timer. The second timer may be a validity timer. The value may indicate (or used to derive) the time that the request and/or the procedure is valid. The value may or may not be zero. The UE may start a second timer (e.g., the validity timer) with the value set to the value included in the response message, e.g., in response to or upon receiving the response message. The UE may consider the procedure as failed if/upon/in response to expiry of the second timer.

The network node may start a third timer, e.g., if/when/in response to suspending the request and/or the procedure. The third timer may be a validity timer. The third timer may be set to a value configured by the ground NW. The value and/or the third timer may indicate (or used to derive) how long the request and/or the procedure is (expected to be) suspended. The network node may terminate the procedure, remove the request (received previously), and/or not transmit (or resume, or forward, or relay) the (previously received) request to the ground NW if/when/upon/in response to/based on expiry of the third timer. The network node may transmit a message to the UE to terminate the procedure, e.g., if/when/upon/in response to/based on expiry of the third timer.

The first timer, the second timer, and/or the third timer may be the same. The first timer, the second timer, and/or the third timer may be different.

The UE may transmit a message to the network node to terminate (or cancel) the procedure, e.g., when the procedure is suspended, when the first timer is running, and/or when the UE does not want to continue the procedure. In response to receiving the message, the network node may terminate (or cancel) the procedure, remove the (previously received) request, and/or not transmit (or resume, or forward, or relay) the (previously received) request to the ground NW.

The network node (e.g., the satellite NW) may receive a response message from the ground NW, e.g., after the procedure is resumed, after the request message is forwarded or relayed to the ground NW, and/or in response to the request message being transmitted to the ground NW. The network node (e.g., the satellite NW) may transmit/forward/relay the response message (received from the ground NW) to the UE, e.g., in response to receiving the response message. The response message may be an accept message of the procedure. In response to receiving the message, the UE may complete the procedure.

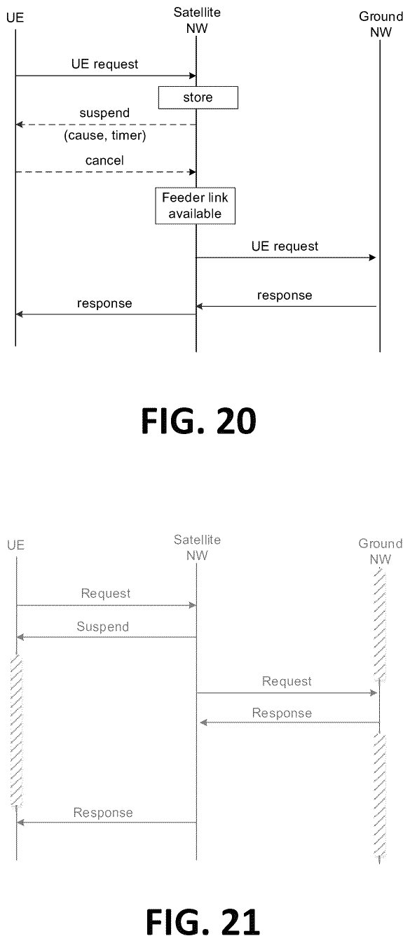

In one or more examples, the network node may receive a request of a first procedure from a UE. The network node may suspend the request if the network node is in S&F mode (or using S&F operation, or the feeder link of the network node is not available). The network node may transmit a response message to the UE to suspend the request. The network node (e.g., the satellite NW) may resume the procedure if/when/in response to/based on the feeder link becomes available (or the ground NW becomes reachable). The network node (e.g., the satellite NW) may transmit (or resume, or forward, or relay) the request to the ground NW, e.g., if/when/in response to/based on the feeder link becomes available (or the ground NW becomes reachable). An example is shown in FIG. 20 or FIG. 21.

The network node may not suspend a request of a second procedure from a UE based on (or due to) S&F mode (or operation) and/or feeder link available.

The first procedure and the second procedure may be different procedures. The first procedure and the second procedure may be the same procedure with different purposes (or causes). The same procedure with a different purpose (or cause) may be considered as a different procedure here.

A different procedure (or transmission) may be handled differently.

To solve the issue, a first network node (e.g., the satellite NW) may act as a proxy of a second network node (e.g., the ground NW). The first network node (e.g., the satellite NW) may handle/process/respond to at least a procedure (or a transmission) on behalf of the second network node (e.g., the ground NW) if (at least) the first network node is in S&F mode (or using S&F operation). The procedure and/or transmission may involve (or be related to, or is associated to) at least a network node (or segment) of the ground NW (e.g., a response message or an accept message or acknowledgement of the procedure and/or transmission is generated by the ground NW, at least in normal mode). The first network node may be (or comprise) the satellite NW. The second network node may be (or comprise) the ground NW.

The UE may transmit a request of the procedure or initiate a transmission to the network (e.g., the first network node). In response to receiving the request or the transmission, the first network node may respond to the request or the transmission (e.g., by transmitting a response or acknowledgment) to the UE. The first network node may (determine whether to) generate and/or transmit a response message of the procedure (or a transmission) to the UE based on one or more of the following conditions:
Operation mode; and/or
   For example, if (or when) the UE is in S&F mode (or using S&F operation).
   For example, if (or when) the UE can only use S&F operation (e.g., for transmission).
   For example, if (or when) the NW (e.g., the satellite NW, the serving cell) is in S&F mode (or using S&F operation).
   For example, the operation mode may be (or comprise) S&F mode. The UE and/or the NW may be in S&F mode.
   For example, the operation mode may be (or comprise) normal mode. The UE and/or the NW may be in normal mode.
Feeder link or ground NW availability; and/or
   For example, if (or when) the feeder link (of the UE, the serving cell, and/or the NW) is available.
   For example, if (or when) the ground NW is reachable.
   For example, the feeder link (of the UE, the serving cell, and/or the NW) may be available.
   For example, the feeder link (of the UE, the serving cell, and/or the NW) may not be available.
Characteristic of the procedure (or transmission); and/or
   For example, if (or when) the procedure (or transmission) is related to the ground NW.
   For example, if (or when) the ground NW is involved in the procedure (e.g., a response message or an accept message is generated by the ground NW).
Service associated with the procedure (or transmission); and/or
   For example, if (or when) a service associated with the procedure can be served (e.g., in S&F mode).
   For example, if (or when) requirement of a service (associated with the procedure) can be fulfilled (e.g., in S&F mode).
   For example, the service may be (or comprise) SMS (short message service).
   For example, the service may be (or comprise) an Internet of Things (IoT) service.
   For example, the service may be (or comprise) a delay-tolerant service.
Purpose of the procedure; and/or
   For example, if (or when) the purpose is for establishment (e.g., a connection, a registration, a service).
   For example, if (or when) the purpose is for modification (e.g., a connection, a registration, a service).
   For example, if (or when) the purpose is for release (e.g., a connection, a registration, a service).
   For example, if (or when) the purpose is for initialization (e.g., a connection, a registration, a service).
   For example, if (or when) the purpose is for periodic update (e.g., a connection, a registration, a service).
   For example, if (or when) the purpose is for mobility update (e.g., a connection, a registration, a service).
Status of the UE; and/or
   For example, if (or when) the UE is (or has been) authenticated, authorized, and/or registered.
   For example, if (or when) the UE is (or has been) connected to the network (e.g., the ground NW).
   For example, if (or when) the UE is (or has been) in a connected state.
Configuration or indication.
   For example, if (or when) a configuration or indication, e.g., from the ground NW, is received (or available).
   For example, if (or when) the network node has a (local or stored) configuration (e.g., for responding or accepting the procedure).
   For example, if (or when) the network node is configured by the ground NW, e.g., to handle/process/respond to the procedure.

The first network node may respond to the transmission or transmit a response message of the procedure (e.g., to accept the request, to acknowledge the transmission) in response to the request (or the transmission) of the UE if/when/in response to/based on at least one or more condition(s) is fulfilled. The first network node may not respond to the transmission or transmit a response message of the procedure (e.g., to accept the request, to acknowledge the transmission) in response to the request (or the transmission) of the UE if/when/in response to/based on at least one or more condition(s) is not fulfilled. The first network node may respond to the transmission or transmit a response message of the procedure (e.g., to reject the request, to suspend the request, to acknowledge the transmission) in response to the request (or the transmission) of the UE if/when/in response to/based on at least one or more condition(s) is not fulfilled. The first network node may suspend the procedure in response to the request of the UE if/when/in response to/based on at least one or more condition(s) is not fulfilled.

The first network node may respond to the transmission or transmit a response message of the procedure (e.g., to accept the request, to acknowledge the transmission) in response to the request (or the transmission) of the UE if/when/in response to/based on at least one or more condition(s) is not fulfilled. The first network node may not respond to the transmission or transmit a response message of the procedure (e.g., to accept the request, to acknowledge the transmission) in response to the request (or the transmission) of the UE if/when/in response to/based on at least one or more condition(s) is fulfilled. The first network node may respond to the transmission or transmit a response message of the procedure (e.g., to reject the request, to suspend the request, to acknowledge the transmission) in response to the request (or the transmission) of the UE if/when/in response to/based on at least one or more condition(s) is fulfilled. The first network node may suspend the procedure in response to the request of the UE if/when/in response to/based on at least one or more condition(s) is fulfilled.

The second network node may provide indication/information/configuration to the first network node about the procedure (or transmission), e.g., how and/or whether to handle/process/respond to the procedure (or a transmission). The indication/information/configuration may be provided in response to a request of the first network node. The indication/information/configuration may be provided when the feeder link is available (or when the first network node is not in S&F mode).

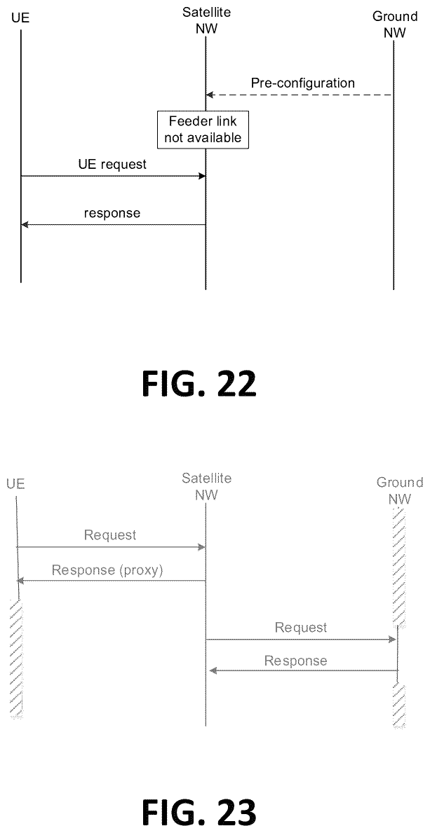

In one or more examples, the first network node (e.g., the satellite NW) may be provided with a configuration (or pre-configured) about a first procedure, e.g., by the second network node (e.g., the ground NW). When the first network node is in S&F mode (e.g., the feeder link is not available), the first network node may receive a request of the first procedure from a UE. The first network node may transmit a response message of the first procedure to accept the request based on the configuration (or pre-configuration). An example is shown in FIG. 22.

In one or more examples, the first network node (e.g., the satellite NW) may (determine to) respond to a transmission from a UE (e.g., in response to receiving the transmission from the UE). The first network node may respond to the transmission by transmitting a response to the UE. The transmission may be an SMS transmission (e.g., RP-DATA). The transmission may be associated with an SMS service. The transmission may be a request. The request may be associated with a procedure. The response may be an acknowledgement (e.g., RP-ACK). The response may be a delivery report.

The first network node may (determine whether to) respond to the transmission based on feeder link (e.g., of the first network node) availability (e.g., if the feeder link is available). For example, the first network node may respond to the transmission if (at least) the feeder link is not available. The first network node may not respond to the transmission if (at least) the feeder link is available. The second network node may (be responsible for) respond to the transmission if (at least) the feeder link is available. The second network node may be Service Centre (SC).

The first network node may (determine whether to) respond to the transmission based on operation mode (of the first network node) (e.g., whether the first network node is in S&F mode or normal mode). The first network node may respond to the transmission if (at least) the first network node is in S&F mode. The first network node may not respond to the transmission if (at least) the first network node is in normal mode. The first network node may not respond to the transmission if (at least) the first network node is not in S&F mode. The second network node may (be responsible for) respond to the transmission if (at least) the first network node is in normal mode (or not in S&F mode).

The first network node may (determine whether to) respond to the transmission based on a service associated with the transmission. The first network node may respond to the transmission if (at least) the service is a first service (e.g., SMS) (or a first procedure). The first service may be (or comprise) an SMS service. The first network node may not respond to the transmission if (at least) the service is a second service (or a second procedure).

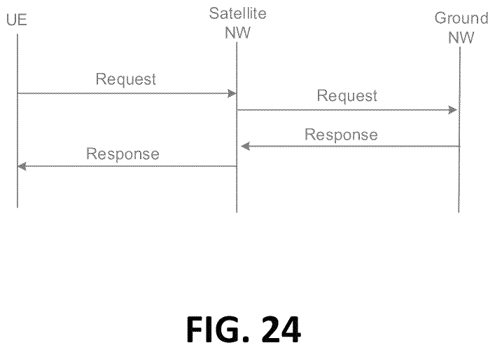

An example is shown in FIG. 23 (for S&F mode) and FIG. 24 (for normal mode). The first network node may not accept the request of a second procedure from a UE when the first network is in S&F mode (or the feeder link is not available).

The first procedure and the second procedure may be different procedures. The first procedure and the second procedure may be the same procedure with different purposes (or causes). The same procedure with a different purpose (or cause) may be considered as a different procedure here.

A different procedure (or transmission) may be handled differently.

The procedure (e.g., the first procedure, the second procedure, the third procedure) or the transmission may be (or comprise) SMS (or associated with SMS).

The procedure (e.g., the first procedure, the second procedure, the third procedure) may be (or comprise) a Non-Access Stratum (NAS) procedure.

The procedure (e.g., the NAS procedure) may be (or comprise) a registration procedure. The procedure (e.g., the NAS procedure) may be (or comprise) a deregistration procedure.

The registration procedure may be for initial registration. The UE may be in Registration Management (RM)-DETEGISTERED state.

The registration procedure may be for mobility registration. The registration procedure may be for periodic registration.

The registration procedure may be for emergency registration. The registration procedure may be for disaster roaming registration.

The procedure (e.g., the NAS procedure) may be (or comprise) a service request procedure.

The procedure (e.g., the NAS procedure) may be (or comprise) a (UE-requested) Protocol Data Unit (PDU) session establishment procedure. The procedure (e.g., the NAS procedure) may be (or comprise) a (UE-requested) PDU session modification procedure. The procedure (e.g., the NAS procedure) may be (or comprise) a (UE-requested) PDU session release procedure.

The procedure (e.g., the NAS procedure) may be (or comprise) a NAS transport procedure.

The procedure (e.g., the NAS procedure) may be (or comprise) an attach procedure. The procedure (e.g., the NAS procedure) may be (or comprise) a detach procedure.

The procedure (e.g., the NAS procedure) may be (or comprise) a tracking area update procedure.

The procedure (e.g., the NAS procedure) may be (or comprise) a Packet Data Network (PDN) connectivity procedure. The procedure (e.g., the NAS procedure) may be (or comprise) a PDN disconnect procedure.

The procedure (e.g., the NAS procedure) may be (or comprise) a bearer resource allocation procedure. The procedure (e.g., the NAS procedure) may be (or comprise) a bearer resource modification procedure.

The procedure (e.g., the first procedure, the second procedure, the third procedure) may be (or comprise) a Radio Resource Control (RRC) procedure.

The procedure (e.g., the RRC procedure) may be (or comprise) an RRC connection establishment procedure.

The procedure (e.g., the RRC procedure) may be (or comprise) an RRC connection re-establishment procedure.

The procedure (e.g., the RRC procedure) may be (or comprise) an RRC connection resume procedure.

The procedure (e.g., the RRC procedure) may be (or comprise) a measurement report procedure.

The procedure (e.g., the RRC procedure) may be (or comprise) an Uplink (UL) information transfer procedure.

The procedure (e.g., the RRC procedure) may be (or comprise) a UE assistance information procedure.

The procedure (e.g., the RRC procedure) may be (or comprise) a UL message segment transfer procedure.

The procedure (e.g., the RRC procedure) may be (or comprise) a sidelink UE information procedure.

The configuration (and/or the indication/parameter) related to S&F (or S&F configuration) may be associated (or specific) to an object. The object may be (or comprise) a UE, a cell, a connection (e.g., RRC connection, NAS connection), a PDU session, and/or a Quality of Service (QOS) flow. The NW may indicate (or configure) which object that the configuration (and/or the indication/parameter) is associated to. The NW may provide (at least) one configuration (and/or the indication/parameter) to (at least) one object.

The configuration (and/or the indication/parameter) related to S&F may be/comprise/be used for/indicate one or more of the following:

### S&F Mode Indication

The indication may (at least) indicate whether the S&F operation is enabled or not (e.g., in the cell, for the UE, to the NW). The indication may (at least) indicate whether a feeder link of the NW is available or not. The indication may (at least) indicate whether the UE is allowed to use S&F operation (e.g., in the cell, to the NW).

The UE may determine (whether) to use S&F operation based on (at least) the indication. For example, if the UE receives the indication, the UE may consider the S&F operation is enabled (and/or activated). If the UE does not receive the indication, the UE may consider the S&F operation is not enabled (and/or activated). If the UE receives the indication, the UE may be allowed to use the S&F operation. If the UE does not receive the indication, the UE may not be allowed to use the S&F operation. The UE may be of a specific UE type. The UE type is illustrated below.

### UE Type

The configuration may (at least) indicate what (type of) UE is allowed to use the S&F operation. The configuration may (at least) indicate what (type of) UE is allowed to perform transmission and/or reception to the NW (e.g., using S&F operation). The transmission and/or reception may be (UP) data and/or (CP) signaling.

The UE type (e.g., a first type) may be based on (or identified by/represented by/specific to) UE capability, UE mobility, QOS characteristic of UE, UE status. The UE type may be (or comprise) (at least) an enhanced Machine-Type Communication (eMTC UE), a Narrowband (NB)-IoT UE, a Reduced Capability (RedCap) UE, a UE supporting New Radio (NR), a UE supporting 5GC, a UE supporting NTN, a UE supporting regenerative payload, a UE with Global Navigation Satellite System (GNSS), and/or a UE supporting S&F operation. The UE type may be (or comprise) (at least) a stationary UE, a low mobility UE, and/or a UE within a limited area. The UE type may be (or comprise) (at least) a UE with low QoS requirement, and/or a UE without Ultra-Reliable Low-Latency Communication (URLLC).

The configuration may (also) be pre-configured. For example, a first type of UE is allowed to use S&F operation if the UE receives the S&F mode indication. For example, a first type of UE is (always) allowed to use S&F operation.

The UE may determine (whether) to use S&F operation based on (at least) the configuration. For example, if the UE receives the configuration and/or the UE belongs to a UE type in the configuration (or pre-configuration), the UE may consider the S&F operation is enabled (and/or activated, and/or allowed). If the UE receives the configuration and/or the UE does not belong to a UE type in the configuration (or pre-configuration), the UE may consider the S&F operation is not enabled (and/or activated, and/or allowed). If the UE does not receive the configuration, the UE may consider the S&F operation is not enabled (and/or activated, and/or allowed).

### Traffic Type

The configuration may (at least) indicate what (type of) traffic is allowed to use S&F operation. The configuration may (at least) indicate what (type of) traffic is allowed to be transmitted to the NW (e.g., using S&F operation). The traffic may be (UP) data and/or (CP) signaling. The traffic may be Access Stratum (AS) level and/or NAS level. The configuration may (also) be pre-configured. The configuration may be based on QoS requirement of the traffic (or the traffic type).

The traffic (or the traffic type) may be based on (or identified by/represented by/specific to) QoS flow, PDU session, radio bearer (Signaling Radio Bearer (SRB) and/or Data Radio Bearer (DRB)), Radio Link Control (RLC) bearer, and/or logical channel.

Explicit configuration may be used for some traffic (or traffic type), and implicit configuration (or pre-configuration) may be used for some (other) traffic (or traffic type). For example, whether a first traffic (or traffic type) is allowed to use S&F operation may be based on the configuration. Whether a second traffic (or traffic type) is allowed to use S&F operation may be based on pre-configuration (e.g., allowed, not allowed, without configuration).

The UE may determine (whether) to use S&F operation (e.g., for a specific traffic or traffic type) based on (at least) the configuration. For example, if the UE receives the configuration and/or the traffic of the UE is included in the configuration (or pre-configuration), the UE may consider the S&F operation is (or is not) enabled (and/or activated, and/or allowed), e.g., for the traffic. If the UE receives the configuration and/or the traffic of the UE is not included in the configuration (or pre-configuration), the UE may consider the S&F operation is not (or is) enabled (and/or activated, and/or allowed), e.g., for the traffic. If the UE receives the configuration and/or the traffic of the UE could fulfill the condition/limitation/restriction/requirement of the configuration (or pre-configuration), the UE may consider the S&F operation is enabled (and/or activated, and/or allowed), e.g., for the traffic. If the UE receives the configuration and/or the traffic of the UE cannot fulfill the condition/limitation/restriction/requirement of the configuration (or pre-configuration), the UE may consider the S&F operation is not (or is) enabled (and/or activated, and/or allowed), e.g., for the traffic. If the UE does not receive the configuration, the UE may consider the S&F operation is (or is not) enabled (and/or activated, and/or allowed), e.g., for every (or all) traffic of the UE.

If the UE consider S&F operation is allowed/enabled/activated for a traffic, the UE may perform transmission (and/or reception) of the traffic (e.g., using S&F operation), initiate a procedure to (or for) performing transmission (and/or reception) of the traffic (e.g., using S&F operation), and/or to request permission/establishment/resource for the traffic (e.g., using S&F operation). The procedure may be a registration procedure (e.g., for initial and/or mobility update), a service request procedure, a PDU session establishment (or modification) procedure.

### QoS Parameter

The parameter may be used by the UE (e.g., based on at least the parameter) to determine (at least) whether QoS requirement of a UE request (e.g., for a service, connection, PDU session, and/or QoS flow) can be fulfilled. The parameter may be used by the UE (e.g., based on at least the parameter) to (at least) determine whether to initiate a UE request (e.g., for a service, connection, PDU session, and/or QoS flow).

The parameter may be (at least) based on (or identified by/represented by/specific to) a UE, a connection, a service, a PDU session, and/or a QoS flow. The configuration may (at least) indicate what type of UE, connection, service, PDU session, and/or QoS flow is associated to the parameter. The parameter may be (at least) based on (or identified by/represented by/specific to) a radio bearer (SRB and/or DRB), RLC bearer, and/or logical channel. The configuration may (at least) indicate what type of radio bearer, RLC bearer, and/or logical channel is associated to the parameter.

The parameter may be (or comprise) (at least) QoS Flow Identifier (QFI), 5G QOS identifier (5QI), Allocation and Retention Priority (ARP), resource type, priority level, packet error rate, averaging window, delay budget (e.g., packet delay budget), and/or data volume (maximum data burst volume).

The parameter may (at least) indicate QoS (related) level/requirement/characteristic(s) allowed to use S&F operation. The parameter may (at least) indicate a maximum QoS level (e.g., latency) that the NW can fulfill. The parameter may (at least) indicate how long the data (or signaling) received from a UE is expected to be stored by the NW before being delivered. The parameter may (at least) indicate how long the response of a UE request is (expected to be) transmitted (or received).

The UE may determine (whether) to use S&F operation (e.g., for a specific object, for a service, for a PDU session) based on (at least) the configuration. For example, if the UE receives the configuration and/or the object of the UE (or the service, or the PDU session) is included in the configuration (or pre-configuration), the UE may consider the S&F operation is (or is not) enabled (and/or activated, and/or allowed), e.g., for the object, for the service, and/or for the PDU session. If the UE receives the configuration and/or the object of the UE (or the service, or the PDU session) is not included in the configuration (or pre-configuration), the UE may consider the S&F operation is not (or is) enabled (and/or activated, and/or allowed), e.g., for the object, for the service, and/or for the PDU session. If the UE receives the configuration and/or the object of the UE (or the service, or the PDU session) could fulfill the condition/limitation/restriction/requirement of the configuration (or pre-configuration), the UE may consider the S&F operation is enabled (and/or activated, and/or allowed), e.g., for the object, for the service, and/or for the PDU session. If the UE receives the configuration and/or the object of the UE (or the service, or the PDU session) cannot fulfill the condition/limitation/restriction/requirement of the configuration (or pre-configuration), the UE may consider the S&F operation is not (or is) enabled (and/or activated, and/or allowed), e.g., for the object, for the service, and/or for the PDU session. If the UE does not receive the configuration, the UE may consider the S&F operation is (or is not) enabled (and/or activated, and/or allowed), e.g., for every (or all) object of the UE (or the service, or the PDU session).

If the UE considers the S&F operation is allowed/enabled/activated for an object (or a service, or a PDU session), the UE may perform transmission (and/or reception) of the object (or the service, or the PDU session) (e.g., using S&F operation), initiate a procedure to (or for) perform transmission (and/or reception) of the object (or the service, or the PDU session) (e.g., using S&F operation), and/or to request permission/establishment/resource for the object (or the service, or the PDU session) (e.g., using S&F operation). The procedure may be a registration procedure (e.g., for initial and/or mobility update), a service request procedure, a PDU session establishment (or modification) procedure.

To determine whether a service (or PDU session, or UE) is allowed to use the S&F operation, at least an object of the service (or PDU session, or UE) needs to fulfill the configured QoS. For example, if no object of the service (or PDU session, or UE) fulfills the configured QoS, the UE may not be allowed to use the S&F operation for the service (or PDU session, or UE). If every object of the service (or PDU session, or UE) fulfills the configured QoS, the UE may be allowed to use the S&F operation for the service (or PDU session, or UE). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use the S&F operation for the first object and not allowed to use the S&F operation for the second object. If some object(s) of the service (or PDU session, or UE) (e.g., a first object) fulfills the configured QoS and some other object(s) of the service (or PDU session, or UE) (e.g., a second object) does not fulfill the configured QoS, the UE may not be allowed to use the S&F operation for the service (or PDU session, or UE) (e.g., including the first object and the second object). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use the S&F operation for the service (or PDU session, or UE) (e.g., including the first object and the second object).

The object may be (or comprise) (at least) a connection, a service, a PDU session, and/or a QoS flow. The object may be (or comprise) (at least) a radio bearer, RLC bearer, and/or logical channel.

### Data Volume

The configuration may (at least) indicate data volume limitation allowed to use the S&F operation. The configuration may (at least) indicate how much data can be transmitted to the NW (e.g., using S&F operation). The data may be (or comprise) UP data and/or CP signaling. The data may be AS level and/or NAS level.

The configuration may be (at least) based on (or identified by/represented by/specific to) a UE, a connection, a service(s), a PDU session(s), and/or a QoS flow(s). The configuration may (at least) indicate what (or which) UE, connection(s), service(s), PDU session(s), and/or QoS flow(s) is associated to the configuration. The configuration may be (at least) based on (or identified by/represented by/specific to) a radio bearer(s) (SRB and/or DRB), RLC bearer(s), and/or logical channel(s). The configuration may (at least) indicate what (or which) radio bearer(s), RLC bearer(s), and/or logical channel(s) is associated to the parameter.

The UE may determine (whether) to use the S&F operation (e.g., for a specific object) based on (at least) the configuration. The UE may determine (whether) to stop the S&F operation (e.g., for a specific object) based on (at least) the configuration. The UE may determine (whether) the S&F operation (e.g., for a specific object) can continue based on (at least) the configuration.

The object may be (or comprise) (at least) a UE, a connection, a service, a PDU session, and/or a QoS flow. The object may be (or comprise) (at least) a radio bearer, RLC bearer, and/or logical channel.

For example, if the UE receives the configuration and/or the traffic of the UE (e.g., for the object) has not exceeded the data volume, the UE may (be allowed to) use the S&F operation, e.g., for the traffic. If the UE receives the configuration and/or the traffic of the UE (e.g., for the object) has exceeded the data volume, the UE may not (be allowed to) use the S&F operation, e.g., for the traffic. If the UE does not receive the configuration, the UE may consider there is no data volume limitation to use the S&F operation, e.g., for the UE, for the object.

If the UE considers that the S&F operation is allowed (e.g., for a traffic), the UE may perform (or continue) transmission (and/or reception) of the traffic (e.g., using S&F operation), initiate (or continue) a procedure to (or for) performing transmission (and/or reception) of the traffic (e.g., using S&F operation), and/or to request permission/establishment/resource for the traffic (e.g., using S&F operation). The procedure may be a registration procedure (e.g., for initial and/or mobility update), a service request procedure, a PDU session establishment (or modification) procedure.

If the UE has transmitted data exceeding the data volume, the UE may stop the S&F operation, stop transmitting data, stop the (ongoing) procedure. If the UE has transmitted data exceeding the data volume, the UE may transmit an indication to the NW (e.g., indicating that the data volume limitation is reached), initiate a (RRC and/or NAS) connection release (request) procedure, initiate a de-registration procedure, and/or initiate a PDU session release (or modification) procedure (e.g., to release a PDU session). If the UE has transmitted data exceeding the data volume, the UE may release a (RRC and/or NAS) connection, and/or go to (RRC and/or NAS) idle mode (e.g., RRC_IDLE, Connection Management (CM)_IDLE).

The NW may be (or comprise) a satellite NW. The satellite NW may be (or comprise) a network node, a CN node, a RAN node, AMF, SMF, MME, RAN, NG-RAN, eNB, gNB, a portion of the above (e.g., a satellite part of the above), and/or a combination of the above.

The NW may be (or comprise) a ground NW. The ground NW may be (or comprise) a network node, a CN node, a RAN node, AMF, SMF, MME, RAN, NG-RAN, eNB, gNB, a portion of the above (e.g., a ground part of the above), and/or a combination of the above.

The satellite NW and the ground NW may be mutually exclusive.

The NW may be (or comprise) a cell. The NW may be (or comprise) a serving cell. The NW may be (or comprise) a neighbor cell. The NW may be (or comprise) a source cell. The NW (or comprise) may be a target cell.

The UE may be in RRC connected mode. The UE may be in RRC idle mode. The UE may be in RRC inactive mode.

The UE may be in CM idle state. The UE may be in CM connected state.

The UE may be in RM deregistered state. The UE may be in RM registered state.

The UE may be in a cell of an NTN. The UE may be connected to a cell of an NTN. The UE may be connected to a LEO, GEO, MEO, HEO, and/or HAPS.

The UE may be referred to as the UE, an RRC entity of the UE or a MAC entity of the UE.

The UE may be an NR device. The UE may be an NR-light device. The UE may be a reduced capability device. The UE may be a mobile phone. The UE may be a wearable device. The UE may be a sensor. The UE may be a stationary device.

The NW may be a network node. The NW may be a base station. The NW may be an access point. The NW may be an eNB. The NW may be a gNB. The NW may be a gateway.

Exemplary embodiments of the present invention are described below.

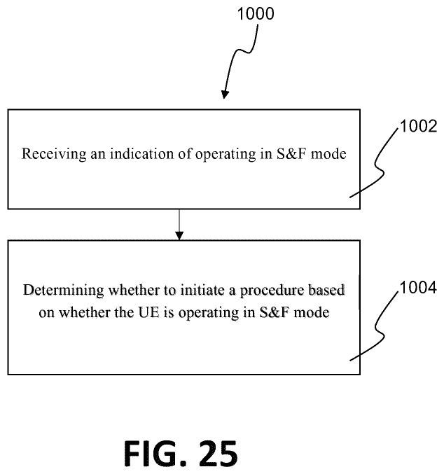

Referring to FIG. 25, with this and other concepts, systems, and methods of the present invention, a method 1000 for a UE in a wireless communication system comprises receiving an indication of operating in S&F mode (step 1002), and determining whether to initiate a procedure based on whether the UE is operating in S&F mode (step 1004).

In various embodiments, the UE is not allowed to initiate a procedure if (at least) the UE is operating in S&F mode.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive an indication of operating in S&F mode; and (ii) determine whether to initiate a procedure based on whether the UE is operating in S&F mode. Moreover, the CPU 308 can execute the program code 312 to perform all of the described actions, steps, and methods described above, below, or otherwise herein.

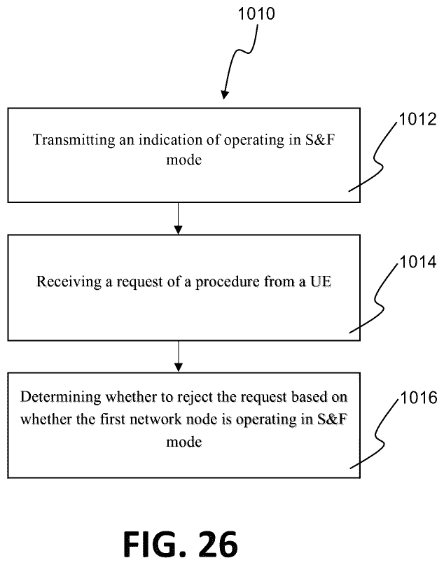

Referring to FIG. 26, with this and other concepts, systems, and methods of the present invention, a method 1010 for a first network node in a wireless communication system comprises transmitting an indication of operating in S&F mode (step 1012), receiving a request of a procedure from a UE (step 1014), and determining whether to reject the request based on whether the first network node is operating in S&F mode (step 1016).

In various embodiments, the first network node transmits a reject message in response to the request if (at least) the first network node is operating in S&F mode.

Referring back to FIGS. 3 and 4, in one or more embodiments from the perspective of a first network node in a wireless communication system, the device 300 includes a program code 312 stored in memory 310 of the transmitter. The CPU 308 could execute program code 312 to: (i) transmit an indication of operating in S&F mode; (ii) receive a request of a procedure from a UE; and (iii) determine whether to reject the request based on whether the first network node is operating in S&F mode. Moreover, the CPU 308 can execute the program code 312 to perform all of the described actions, steps, and methods described above, below, or otherwise herein.

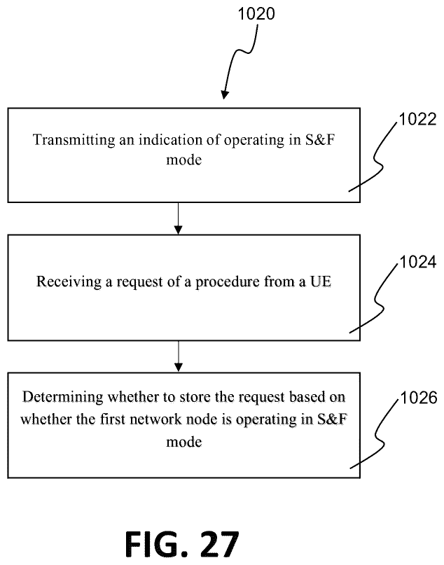

Referring to FIG. 27, with this and other concepts, systems, and methods of the present invention, a method 1020 for a first network node in a wireless communication system comprises transmitting an indication of operating in S&F mode (step 1022), receiving a request of a procedure from a UE (step 1024), and determining whether to store the request based on whether the first network node is operating in S&F mode (step 1026).

In various embodiments, the first network node stores the request if (at least) the first network node is operating in S&F mode.

In various embodiments, the first network node transmits the request to a second network node when (at least) the first network node leaves S&F mode.

Referring back to FIGS. 3 and 4, in one or more embodiments from the perspective of a first network node in a wireless communication system, the device 300 includes a program code 312 stored in memory 310 of the transmitter. The CPU 308 could execute program code 312 to: (i) transmit an indication of operating in S&F mode; (ii) receive a request of a procedure from a UE; and (iii) determine whether to store the request based on whether the first network node is operating in S&F mode. Moreover, the CPU 308 can execute the program code 312 to perform all of the described actions, steps, and methods described above, below, or otherwise herein.

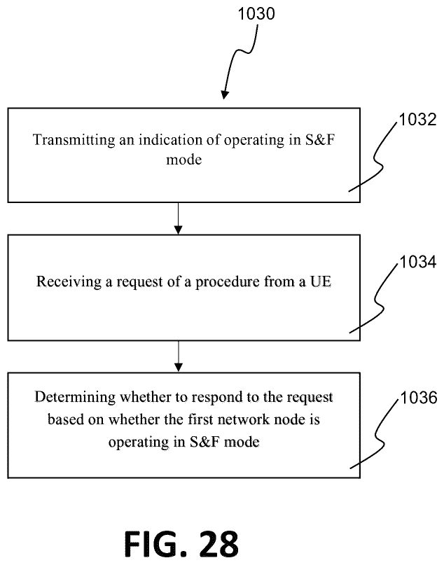

Referring to FIG. 28, with this and other concepts, systems, and methods of the present invention, a method 1030 for a first network node in a wireless communication system comprises transmitting an indication of operating in S&F mode (step 1032), receiving a request of a procedure from a UE (step 1034), and determining whether to respond to the request based on whether the first network node is operating in S&F mode (step 1036).

In various embodiments, the method further comprises the first network node determining whether to respond to the request based on whether the first network node receives a configuration about the procedure from a ground NW.

In various embodiments, the first network node is located or deployed in a satellite.

Referring back to FIGS. 3 and 4, in one or more embodiments from the perspective of a first network node in a wireless communication system, the device 300 includes a program code 312 stored in memory 310 of the transmitter. The CPU 308 could execute program code 312 to: (i) transmit an indication of operating in S&F mode; (ii) receive a request of a procedure from a UE; and (iii) determine whether to respond to the request based on whether the first network node is operating in S&F mod. Moreover, the CPU 308 can execute the program code 312 to perform all of the described actions, steps, and methods described above, below, or otherwise herein.

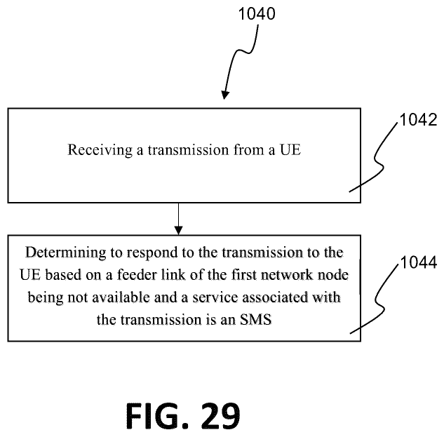

Referring to FIG. 29, with this and other concepts, systems, and methods of the present invention, a method 1040 for a first network node in a wireless communication system comprises receiving a transmission from a UE (step 1042), and determining to respond to the transmission to the UE based on a feeder link of the first network node being not available and a service associated with the transmission is an SMS (step 1044).

In various embodiments, the first network node is in S&F mode or transmits an S&F mode indication to the UE.

In various embodiments, the first network node determines to respond to the transmission to the UE based on the feeder link availability of the first network node, the service associated with the transmission, and/or whether the first network node is in S&F mode.

In various embodiments, a response of the transmission is generated by a second network node when the feeder link of the first network node is available and/or the first network node is in normal mode.

In various embodiments, the second network node is on ground, a ground network, and/or comprises another portion of an MME.

In various embodiments, the first network node responds to the transmission to the UE on behalf of a second network node.

In various embodiments, the first network node is on a satellite, a satellite network, and/or comprises a portion of an MME.

In various embodiments, the feeder link is between the first network node and a second network node.

In various embodiments, the first network node stores the transmission when the feeder link of the first network node is not available and/or the first network node is in S&F mode.

In various embodiments, the S&F mode enables satellite access providing a level of service when satellite connectivity is temporarily unavailable.

Referring back to FIGS. 3 and 4, in one or more embodiments from the perspective of a first network node in a wireless communication system, the device 300 includes a program code 312 stored in memory 310 of the transmitter. The CPU 308 could execute program code 312 to: (i) receive a transmission from a UE; and (ii) determine to respond to the transmission to the UE based on a feeder link of the first network node being not available and a service associated with the transmission is an SMS. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a first network node, comprising:
receiving a transmission from a User Equipment (UE); and
determining to respond to the transmission to the UE based on a feeder link of the first network node being not available and a service associated with the transmission is a Short Message Service (SMS).

2. The method of claim 1, wherein the first network node is in Store and Forward (S&F) mode or transmits an S&F mode indication to the UE.

3. The method of claim 1, wherein the first network node determines to respond to the transmission to the UE based on the feeder link availability of the first network node, the service associated with the transmission, and/or whether the first network node is in S&F mode.

4. The method of claim 1, wherein a response of the transmission is generated by a second network node when the feeder link of the first network node is available and/or the first network node is in normal mode.

5. The method of claim 1, wherein the first network node responds to the transmission to the UE on behalf of a second network node.

6. The method of claim 1, wherein the first network node is on a satellite, a satellite network, and/or comprises a portion of a Mobile Management Entity (MME).

7. The method of claim 4, wherein the second network node is on ground, a ground network, and/or comprises another portion of an MME.

8. The method of claim 1, wherein the feeder link is between the first network node and a second network node.

9. The method of claim 1, wherein the first network node stores the transmission when the feeder link of the first network node is not available and/or the first network node is in S&F mode.

10. The method of claim 1, wherein the S&F mode enables satellite access providing a level of service when satellite connectivity is temporarily unavailable.

11. A first network node, comprising:
a memory; and
a processor operatively coupled with the memory, wherein the processor is configured to execute a program code to:
receive a transmission from a User Equipment (UE); and
determine to respond to the transmission to the UE based on a feeder link of the first network node being not available and a service associated with the transmission is a Short Message Service (SMS).

12. The first network node of claim 11, wherein the first network node is in Store and Forward (S&F) mode or transmits an S&F mode indication to the UE.

13. The first network node of claim 11, wherein the first network node determines to respond to the transmission to the UE based on the feeder link availability of the first network node, the service associated with the transmission, and/or whether the first network node is in S&F mode.

14. The first network node of claim 11, wherein a response of the transmission is generated by a second network node when the feeder link of the first network node is available and/or the first network node is in normal mode.

15. The first network node of claim 11, wherein the first network node responds to the transmission to the UE on behalf of a second network node.

16. The first network node of claim 11, wherein the first network node is on a satellite, a satellite network, and/or comprises a portion of a Mobile Management Entity (MME).

17. The first network node of claim 14, wherein the second network node is on ground, a ground network, and/or comprises another portion of an MME.

18. The first network node of claim 11, wherein the feeder link is between the first network node and a second network node.

19. The first network node of claim 11, wherein the first network node stores the transmission when the feeder link of the first network node is not available and/or the first network node is in S&F mode.

20. The first network node of claim 11, wherein the S&F mode enables satellite access providing a level of service when satellite connectivity is temporarily unavailable.
